(19) United States
(12) Patent Application Publication
(10) Pub. No.: US 2026/0142752 A1
(43) Pub. Date: May 21, 2026

(54) TRANSPARENT MULTI-LEVEL CODING AND BIT-INTERLEAVED CODED MODULATION ARCHITECTURE

(71) Applicant: QUALCOMM Incorporated, San Diego, CA (US)

(72) Inventors: Peer BERGER, Hod Hasharon (IL); Shay LANDIS, Hod Hasharon (IL); Jacob PICK, Mevaseret Zion (IL)

(21) Appl. No.: 18/950,992

(22) Filed: Nov. 18, 2024

(51) Int. Cl. H04L 1/00

(52) U.S. Cl. CPC H04L 1/0071; H04L 1/0058; H04L 1/0061

(57) ABSTRACT

Various aspects of the present disclosure generally relate to wireless communication. Some aspects relate to polar encoding and decoding of communications. Aspects described herein provide techniques by which two forms of polar encoding, bit-interleaved coded modulation (BICM) and multi-level coding (MLC) can be implemented using the same transmit procedure and hardware. For example, aspects described herein provide for a modulation constellation labeling associated with one form of polar coding, such as a set partitioning labeling, to be transformed such that polar coding using the transformed modulation constellation and BICM is equivalent to MLC polar coding. Aspects described herein also provide signaling related to these techniques.

### FIELD OF THE DISCLOSURE

Aspects of the present disclosure generally relate to wireless communication and specifically relate to techniques, apparatuses, and methods associated with a transparent multi-level coding and bit-interleaved coded modulation architecture.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

A wireless communication device may encode communications to improve reliability and data capacity. For example, a transmitter in a wireless communication network, such as a 5G or 6G network, may encode a channel (such as a physical downlink control channel or a physical downlink shared channel) with an error correcting code, which provides for detection and/or correction of errors at a receiver. One form of code is a polar code. A polar code provides for information bits of an input to be mapped to more reliable bit positions for coding. Other values, such as parity bits or known values, may be mapped to less reliable bit positions for coding. Polar coding may be accomplished using a polar transform, which is described elsewhere herein.

Coding, such as polar coding, may be based on a modulation constellation. A modulation constellation may indicate a mapping between a constellation point (representing a combination of an in-phase amplitude and a quadrature amplitude) and a bit string. For example, a modulation constellation for quadrature phase shift keying (QPSK) may include four constellation points, and each constellation point may correspond to one of four two-bit values. QPSK has a modulation order of m=2, since there are 2^{m}=4 constellation points and m=2 bit positions in QPSK. Polar coding can be implemented with higher-order modulation schemes (m>2), such as 16 quadrature amplitude modulation (QAM) (16-QAM, in which m=4) or 64-QAM, in which m=6. Different approaches for implementing polar coding with higher-order modulation schemes are associated with different levels of complexity and performance with regard to implementation and coding performance.

### SUMMARY

Certain aspects provide a method for wireless communications by a transmitter. The method includes encoding information, using polar coding and a polar-transformed labeling, to obtain encoded information, wherein the polar-transformed labeling is according to a polar transformation or an inverse polar transformation of a labeling scheme; and transmitting the encoded information.

Certain aspects provide a method for wireless communications by a user equipment (UE). The method includes transmitting or receiving a configuration associated with encoding or decoding a communication using polar coding and a polar-transformed labeling; and performing the communication according to the configuration.

Certain aspects provide a method for wireless communications by a network entity. The method includes transmitting or receiving a configuration associated with encoding or decoding a communication using polar coding and a polar-transformed labeling; and performing the communication according to the configuration.

Certain aspects provide an apparatus for wireless communications. The apparatus includes a processing system that includes one or more processors and one or more memories coupled with the one or more processors, the processing system configured to cause a transmitter to: encode information, using polar coding and a polar-transformed labeling, to obtain encoded information, wherein the polar-transformed labeling is according to a polar transformation or an inverse polar transformation of a labeling scheme; and transmit the encoded information.

Certain aspects provide an apparatus for wireless communications. The apparatus includes a processing system that includes one or more processors and one or more memories coupled with the one or more processors, the processing system configured to cause a user equipment (UE) to: transmit or receive a configuration associated with encoding or decoding a communication using polar coding and a polar-transformed labeling; and perform the communication according to the configuration.

Certain aspects provide an apparatus for wireless communications. The apparatus includes a processing system that includes one or more processors and one or more memories coupled with the one or more processors, the processing system configured to cause a network entity to: transmit or receive a configuration associated with encoding or decoding a communication using polar coding and a polar-transformed labeling; and perform the communication according to the configuration.

Certain aspects provide one or more non-transitory computer-readable media. The one or more non-transitory computer-readable media includes executable instructions that, when executed by one more processors of an apparatus, cause the apparatus to encode information, using polar coding and a polar-transformed labeling, to obtain encoded information, wherein the polar-transformed labeling is according to a polar transformation or an inverse polar transformation of a labeling scheme; and transmit the encoded information.

Certain aspects provide one or more non-transitory computer-readable media. The one or more non-transitory computer-readable media includes executable instructions that, when executed by one more processors of an apparatus, cause the apparatus to transmit or receive a configuration associated with encoding or decoding a communication using polar coding and a polar-transformed labeling; and perform the communication according to the configuration.

Certain aspects provide one or more non-transitory computer-readable media. The one or more non-transitory computer-readable media includes executable instructions that, when executed by one more processors of an apparatus, cause the apparatus to transmit or receive a configuration associated with encoding or decoding a communication using polar coding and a polar-transformed labeling; and perform the communication according to the configuration.

Certain aspects provide an apparatus for wireless communications. The apparatus includes means for encoding information, using polar coding and a polar-transformed labeling, to obtain encoded information, wherein the polar-transformed labeling is according to a polar transformation or an inverse polar transformation of a labeling scheme; and means for transmitting the encoded information.

Certain aspects provide an apparatus for wireless communications. The apparatus includes means for transmitting or receiving a configuration associated with encoding or decoding a communication using polar coding and a polar-transformed labeling; and means for performing the communication according to the configuration.

Certain aspects provide an apparatus for wireless communications. The apparatus includes means for transmitting or receiving a configuration associated with encoding or decoding a communication using polar coding and a polar-transformed labeling; and means for performing the communication according to the configuration.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example disaggregated network entity architecture.

FIG. 3 depicts aspects of network entities and a user equipment (UE).

FIG. 4 is a diagram illustrating an example of polar coding.

FIG. 5 is a diagram illustrating an example of multi-level coding (MLC) and a modulation constellation labeling 502 is compatible with MLC.

FIG. 6 is a diagram illustrating an example of bit-interleaved coded modulation (BICM) and a modulation constellation labeling that is compatible with BICM.

FIG. 7 is a diagram illustrating an example of polar transformation of a modulation constellation labeling.

FIG. 8 is a diagram illustrating an example of encoding and decoding with a polar-transformed labeling.

FIG. 9 is a diagram illustrating an example of signaling between a UE and a network entity related to transparent polar coding implementation.

FIGS. 10A-10E are diagrams illustrating examples of polar encoding with BICM and MLC.

FIG. 11 depicts a method for wireless communications.

FIG. 12 depicts another method for wireless communications.

FIG. 13 depicts another method for wireless communications.

FIG. 14 depicts aspects of an example communications device.

FIG. 15 depicts aspects of an example communications device.

FIG. 16 depicts aspects of an example communications device.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Polar coding can be used to perform channel coding and modulation, thereby enabling error detection and correction while approaching or achieving channel capacity. The polar coding may be performed in connection with a modulation constellation in order to implement coded modulation of a communication. For example, a transmitter may perform polar coding on an input to generate an output, and may map the output to a modulation constellation in order to generate a set of modulation symbols for transmission. A receiver may perform decoding (such as successive cancellation or another form of decoding) on a received set of modulation symbols to obtain the input.

It may be beneficial to extend polar coding to higher orders (m>1), such that multiple bits can be encoded or modulated into a single modulation symbol, to support higher data rates. For example, it may be beneficial to extend polar coding to support higher orders associated with more complex modulation schemes such as 16 quadrature amplitude modulation (QAM) (16-QAM) or 64-QAM. Various schemes have been proposed to enable and improve efficiency of polar coding (such as coded modulation) and decoding (such as demodulation and decoding) for higher orders. One example scheme is bit-interleaved coded modulation (BICM). Another example scheme is multi-level coding (MLC). In BICM, a single polar coding operation is used for multiple bit positions of a modulation symbol, whereas in MLC, a separate polar coding operation is used for each bit position (in the binary case, or symbol position in the non-binary case) of the modulation symbol. BICM may provide for lower-complexity decoding than MLC because MLC uses a recursive de-mapping process (in which log likelihood ratios are generated for each outer code given previously decoded bits of a modulation symbol). MLC may provide a higher performance (such as optimal performance, as indicated by the information chain rule) and simpler encoding than BICM. Notably, BICM and MLC benefit from the use of different modulation constellation labeling. For example, BICM may perform well with a Gray labeling, whereas MLC may perform well with a set partitioning (SP) labeling.

A transmitter or receiver may include hardware or a module that implements polar coding. Some transmitters and/or receivers may implement one of the above schemes and not the other. For example, a transmitter and/or receiver may implement MLC for higher-order polar coding and modulation, but not BICM. As another example, a transmitter and/or receiver may implement BICM for higher-order polar coding and modulation, but not MLC. It may be beneficial for a transmitter or receiver to implement a different scheme than the one supported by the transmitter or receiver. For example, a transmitter or receiver that includes a module or hardware that implements BICM may benefit from using MLC due to the improved performance of MLC, particularly at the decoder/receiver. However, BICM and MLC may use different implementations with regard to modulation constellation labeling, decoding, and so on, which creates difficulties in switching between these schemes or supporting multiple schemes at a transmitter or receiver. Furthermore, polar coding and decoding may benefit from mutual understanding between the transmitter and receiver of certain parameters such as frozen bit locations or modulation constellation labeling. Without this information, decoding may be impossible.

Aspects of the present disclosure relate generally to implementing both of MLC and BICM using a same encoding and/or transmission scheme. For example, a transmitter may perform polar coding (such as for coded modulation of a communication) using a polar-transformed labeling. The polar-transformed labeling may be generated via a polar transformation of a modulation constellation labeling scheme. For example, when the polar coding is performed using BICM, the labeling scheme from which the polar-transformed labeling is derived may be a set partitioning labeling scheme. When the polar coding is performed using MLC, the labeling scheme from which the polar-transformed labeling is derived may be a Gray labeling scheme. By generating the polar-transformed labeling using the polar transformation, MLC-based polar coding can be implemented using a BICM-based polar coding configuration at the transmitter, or BICM-based polar coding can be implemented using an MLC-based polar coding configuration at the transmitter. Furthermore, some aspects described herein provide configuration of various parameters for transmission and reception of communications encoded according to aspects described herein, such as a set of frozen bits, an indication of whether to perform MLC or BICM-based polar coding, or a polar-transformed labeling to use.

Aspects of the present disclosure may be used to realize one or more of the following potential advantages. In some aspects, by performing the polar coding using the polar-transformed labeling, aspects described herein simplify implementation of polar coding and enable usage of multiple higher-order polar coding schemes by a transmitter or receiver configured to use a single higher-order polar coding scheme. For example, both BICM and MLC can be implemented at a device that supports only one of BICM or MLC for polar coding. Furthermore, performing BICM with the polar-transformed labeling provides equivalent encoding to MLC at a lower level of complexity than supporting MLC for the polar coding. By providing transmission and reception of the configuration, mutual understanding of the parameters used to perform encoding and decoding described herein is achieved, thereby reducing the occurrence of failed decoding and improving adaptability to changing conditions.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

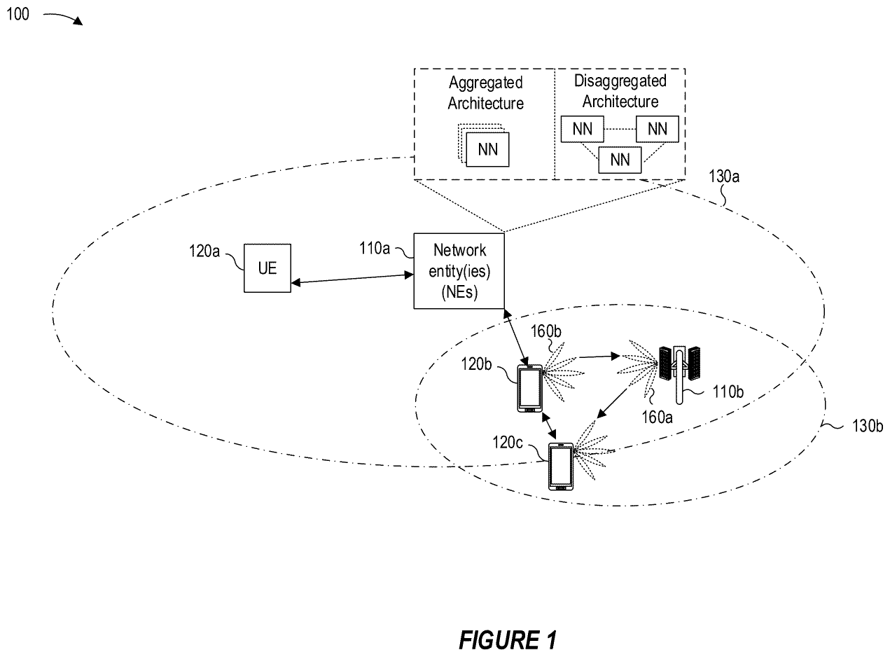

FIG. 1 is a diagram illustrating an example of a wireless communication network 100. The wireless communication network 100 may be or may include elements of a 5G (or NR) network or a 6G network, among other examples. The wireless communication network 100 may include multiple network entities 110. For example, in FIG. 1, the wireless communication network 100 includes a network entity (NE) 110a and a network entity 110b. The network entities 110 may support communications with multiple UEs 120. For example, in FIG. 1, the network entities 110 support communication with a UE 120a, a UE 120b, and a UE 120c. In some examples, a UE 120 may also communicate with other UEs 120 and a network entity 110 may communicate with a core network and with other network entities 110.

The network entities 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHZ.

A network entity 110 may be, may include, or may also be referred to as an NR network entity, a 5G network entity, a 6G network entity, a Node B, a gNB, an access point (AP), a transmission reception point (TRP), a network entity, a network element, a network equipment, and/or another type of device, component, or system included in a RAN. In various deployments, a network entity 110 may be implemented as a single physical node (for example, a single physical structure) or may be implemented as two or more physical nodes (for example, two or more distinct physical structures). For example, a network entity 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network entity 110 may be an aggregated network entity having an aggregated architecture, meaning that the network entity 110 may implement a full radio protocol stack that is physically and logically integrated within a single physical structure in the wireless communication network 100. For example, an aggregated network entity 110 may consist of a single standalone base station or a single TRP that operates with a full radio protocol stack to enable or facilitate communication between a UE 120 and a core network of the wireless communication network 100.

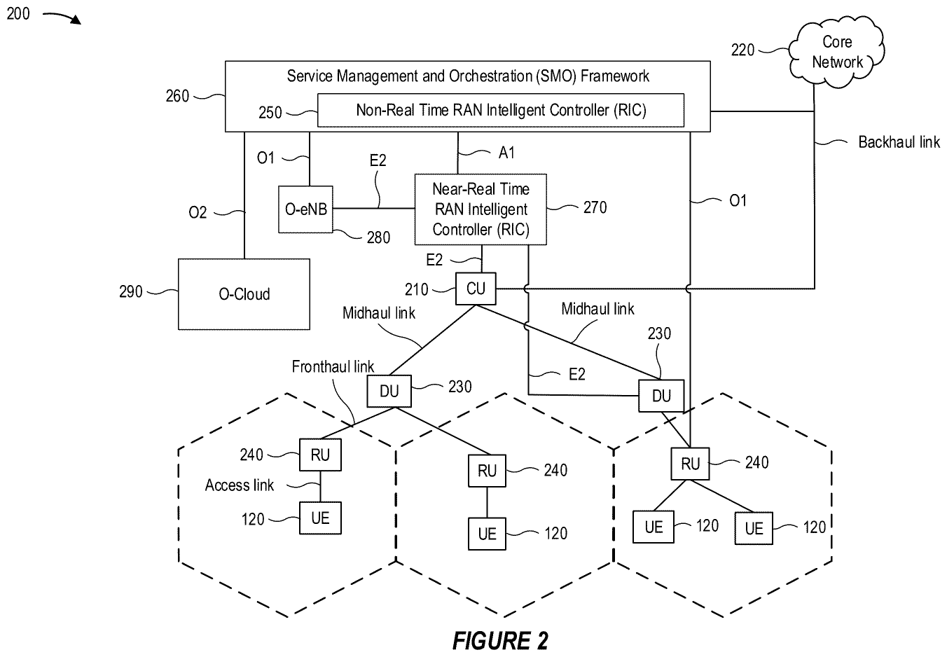

Alternatively, and as also shown, a network entity 110 may be a disaggregated network entity (sometimes referred to as a disaggregated base station), having a disaggregated architecture, meaning that the network entity 110 may operate with a radio protocol stack that is physically distributed and/or logically distributed among two or more nodes in the same geographic location or in different geographic locations. An example disaggregated network entity architecture is described in more detail below with reference to FIG. 2. In some deployments, disaggregated network entities 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network entities 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network entity 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network entities 110 (for example, a base station, an RU, or a TRP) may provide communication coverage for a particular geographic area. The term “cell” can refer to a coverage area of a network entity 110 or to a network entity 110 itself, depending on the context in which the term is used. A network entity 110 may support one or more cells (for example, each cell may support communication within an angular (for example, 60 degree) range around the network entity). In some examples, a network entity 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network entity 110 (for example, a train, a satellite, an unmanned aerial vehicle, or an NTN network entity).

The wireless communication network 100 may be a heterogeneous network that includes network entities 110 of different types, such as macro network entities, pico network entities, femto network entities, relay network entities, aggregated network entities, and/or disaggregated network entities, among other examples. Various different types of network entities 110 may generally transmit at different power levels, serve different coverage areas (for example, a cell 130a and a cell 130b), and/or have different impacts on interference in the wireless communication network 100 than other types of network entities 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network entity, and/or any other suitable device or function that may communicate via a wireless medium.

In some examples, a network entity 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network entity 110 to a UE 120, and “uplink” (or “UL”) refers to a communication direction from a UE 120 to a network entity 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

In some examples, a UE 120 and a network entity 110 may perform MIMO communication “MIMO” generally refers to transmitting or receiving multiple signals (such as multiple layers or multiple data streams) simultaneously over the same time and frequency resources. MIMO techniques generally exploit multipath propagation. A network entity 110 or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network entity 110b may generate one or more beams 160a and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network entity 110 and/or at the UE 120, such as in a network implementing mmWave technology. Massive MIMO may improve communication reliability by enabling a network entity 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

FIG. 2 is a diagram illustrating an example disaggregated network entity architecture 200. One or more components of the example disaggregated network entity architecture 200 may be, may include, or may be included in one or more network entities (such one or more network entities 110). The disaggregated network entity architecture 200 may include a CU 210 that can communicate directly with a core network 220 via a backhaul link, or that can communicate indirectly with the core network 220 via one or more disaggregated control units, such as a Non-RT RAN intelligent controller (RIC) 250 associated with a Service Management and Orchestration (SMO) Framework 260 and/or a Near-RT RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network entity architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, artificial intelligence or machine learning (AI/ML) workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

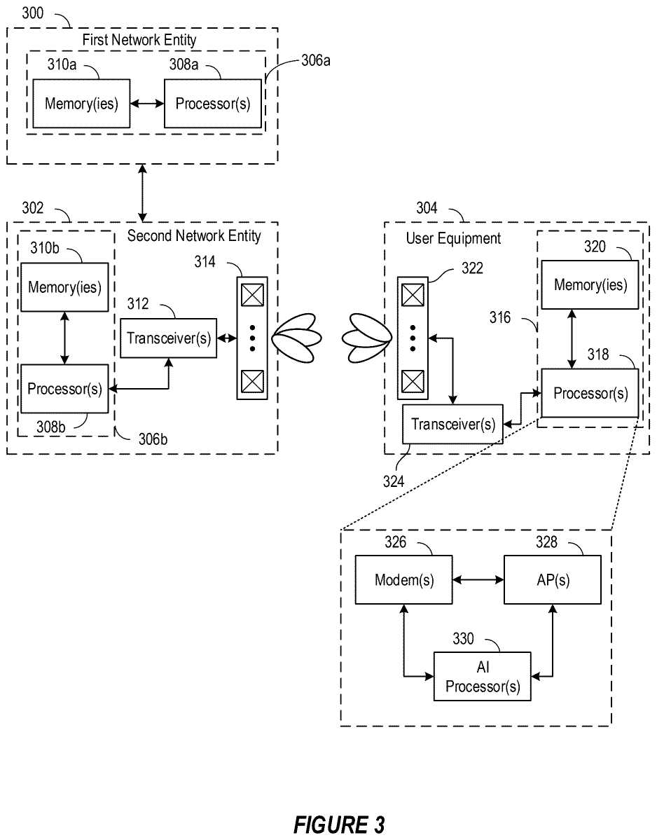

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (for example, network entity 110). For example, first network entity 300 and second network entity 302 may be co-located. In some other examples, first network entity 300 may be implemented separately from second network entity 302. For example, first network entity 300 may be implemented as a function (for example, one or more processes) running on a server, such as in a cloud (for example, a public or private cloud). As another example, first network entity 300 may be implemented as a virtual computing instance (for example, virtual machine or container) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (for example, radio, air interface) communication with other devices such as UE 304. The one or more transceivers 312 may include one or more radio frequency (RF) components, such as an RF transceiver, a front-end module (for example, an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3. The term “antenna module” may refer to circuitry including one or more antennas as well as one or more other components (such as filters, amplifiers, or processors) associated with integrating the antenna module into a wireless communication device such as the network entity 300 or 302 or the UE 304.

UE 304 may be an example of UE 120. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (for example, via modulation) and/or converts the waveform of a received signal into information (for example, via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (for example, for transmissions) or a data sink (for example, for receptions).

The one or more transceivers 324 may perform processing related to implementing physical layer (for example, radio, air interface) communication with other devices such as other UEs 304 or second network entity 302. The one or more transceivers 324 may include one or more RF components, such as an RF transceiver, a front-end module (for example, an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (for example, a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (for example, a transmit processor) may process (for example, encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (for example, a TX MIMO processor) may perform spatial processing (for example, precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (for example, convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (for example, filter, amplify, downconvert, and digitize) the received signals to obtain input samples. The one or more transceivers 324 and/or the processing system 316 may further process the input samples to obtain received symbols.

The processing system 316 (for example, modem 326, an RX MIMO detector) may obtain the received symbols, perform MIMO detection on the received symbols if applicable, and provide detected symbols. The processing system 316 (for example, a modem 326, a receive processor) may process (for example, de-interleave and decode) the detected symbols. The processing system 316 may provide decoded data for the UE 304 (for example, to an AP 328) and/or decoded control information (for example, to a controller/processor of the processing system 316).

For an example uplink transmission or a sidelink transmission from UE 304, the processing system 316 (for example, modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (for example, a modem 326, the transmit processor) may also generate reference symbols for a reference signal (for example, for a sounding reference signal (SRS), a demodulation reference signal, a phase tracking reference signal, or the like). In some examples, the symbols and/or reference signals may be precoded by the processing system 316 (for example, modem 326, a TX MIMO processor), further processed by the one or more transceivers 324 (for example, for single carrier frequency division multiplexing (SC-FDM)), and transmitted to second network entity 302.

At second network entity 302, the uplink signals from UE 304 may be received by the one or more antennas 314, conditioned by the one or more transceivers 312 (for example, filtered, amplified, downconverted, and digitized), detected (for example, by the processing system 306b such as a modem and/or an RX MIMO detector), and further processed by the processing system 306b (for example, a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, network entity 110, UE 120, or UE 304, may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). Some aspects and techniques as described herein may be implemented, at least in part, using an AI program (for example, referred to herein as an “AI/ML model”), such as a program that includes a machine learning (ML) model and/or an artificial neural network (ANN) model. The AI/ML model may be deployed at a device (for example, a network entity 300 or 302, a UE 304, an AI/ML server). For example, the AI/ML model may be deployed at a UE 304 (for example, the processing system 316), a network entity 110 (for example, the processing system 306), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 304 and a second portion of the AI/ML model may be deployed at a network entity 300 or 302). In other examples, a first AI/ML model may be deployed at a UE 304 and a second AI/ML model may be deployed at a network entity 300 or 302. The AI/ML model(s) may be configured to enhance various aspects of wireless communication. For example, the AI/ML model(s) may be trained to identify patterns or relationships in data corresponding to the wireless communication, a device, and/or an air interface, among other examples. The AI/ML model(s) may support operational decisions relating to one or more aspects associated with wireless communications devices, networks, or services.

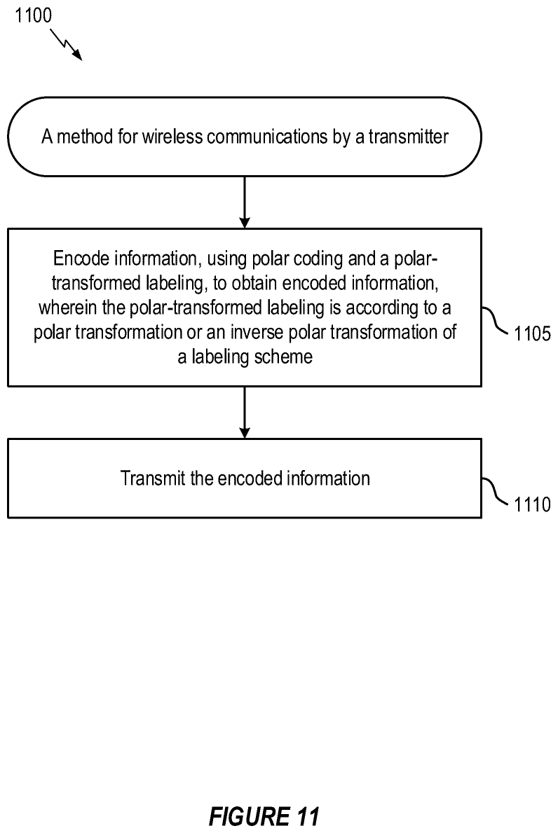

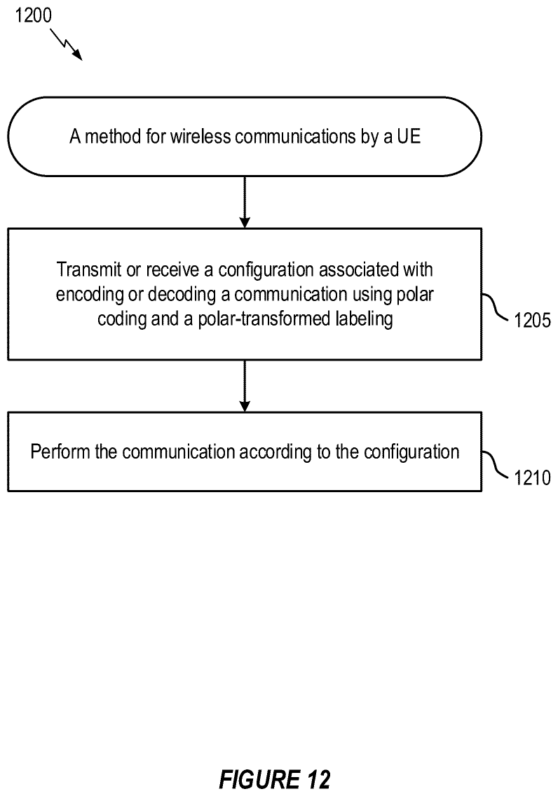

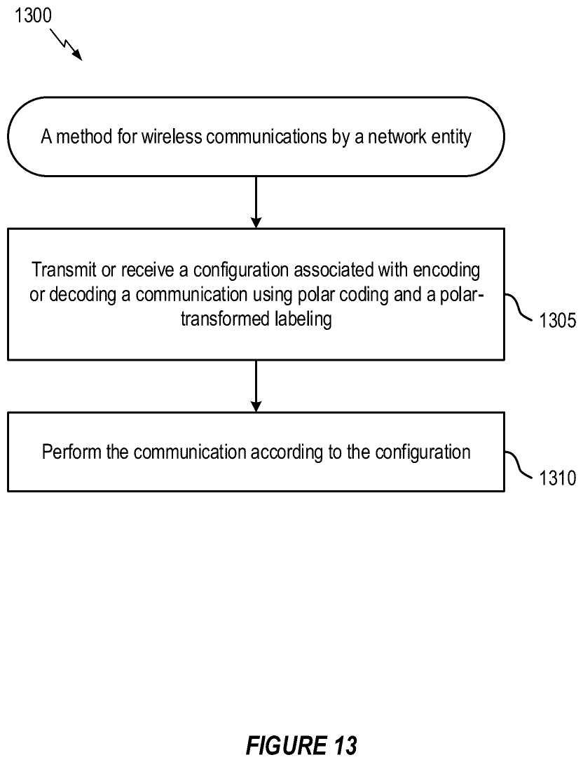

The network entity 110, the UE 120, the CU 210, the DU 230, the RU 240, the network entity 300 or 302, the processing system 306, the UE 304, the processing system 316, or any other component(s) of FIGS. 1, 2, and/or 3 may implement one or more techniques or perform one or more operations associated with validity determination for a PRACH occasion in an SBFD resource, as described in more detail elsewhere herein. For example, the network entity 110, network entity 300, or network entity 302 (collectively, “network entity 110/300/302”), the UE 120 or UE 304 (collectively, “UE 120/304”), the CU 210, the DU 230, the RU 240, the processing system 306, or the processing system 316 may perform or direct operations of, for example, process 1100 of FIG. 11, process 1200 of FIG. 12, process 1300 of FIG. 13, or other processes as described herein (alone or in conjunction with one or more other processors). Memory of the network entity 110/300/302 may store data and program code (or instructions) for the network entity 110/300/302, the CU 210, the DU 230, or the RU 240. In some examples, the memory of the network entity 110/300/302 may store data relating to a UE 120/304, such as RRC state information or a UE context. Memory of the UE 120/304 may store data and program code (or instructions) for the UE 120/304, such as context information. In some examples, the memory of the UE 120/304 or the memory of the network entity 110/300/302 may include a non-transitory computer-readable medium storing a set of instructions for wireless communication. For example, the set of instructions, when executed by one or more processors (for example, the one or more processors 308 or the one or more processors 318) of the network entity 110/300/302, the UE 120/304, the CU 210, the DU 230, or the RU 240, may cause the one or more processors to perform process 1100 of FIG. 11, process 1200 of FIG. 12, process 1300 of FIG. 13, or other processes as described herein. In some examples, executing instructions may include running the instructions, converting the instructions, compiling the instructions, and/or interpreting the instructions, among other examples.

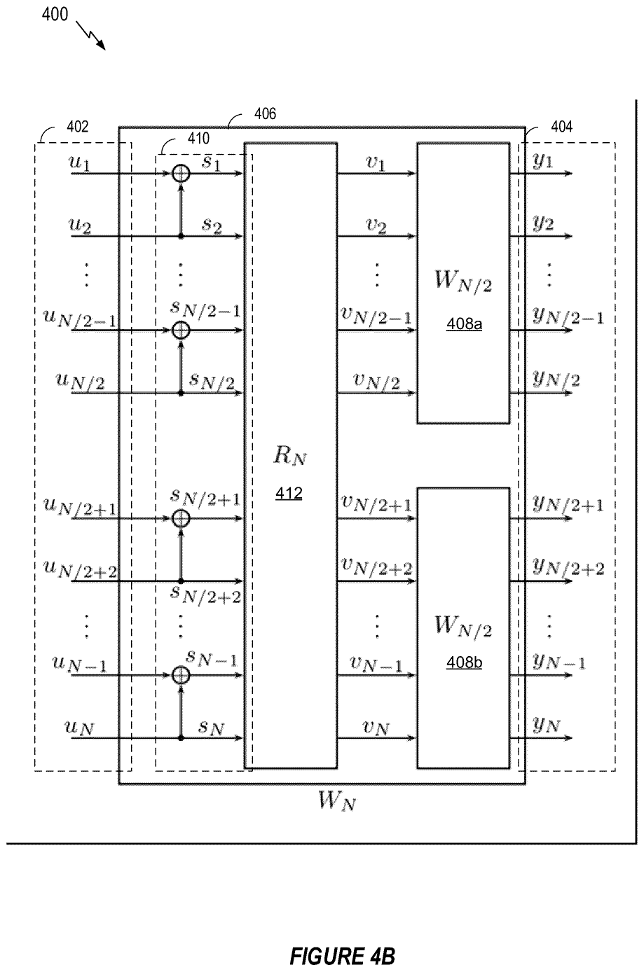

FIG. 4 is a diagram illustrating an example 400 of polar coding. Example 400 illustrates a set of inputs 402 and a set of outputs 404. The set of inputs 402 may be referred to as input information. As shown, the set of inputs 402 has a same length as the set of outputs 404. In example 400, the polar code illustrated by reference number 406 is of size N. However, it should be noted that the polar code illustrated by reference number 406 can be implemented as a plurality of polar codes, for example, as illustrated by reference numbers 408a and 408b. The polar code illustrated by reference number 406 may have an inner code W_{N}. The two polar codes may have respective inner codes W_{N/2}. In some other examples, the polar code may be implemented with N/2 inner codes, each having a size of 2, or any other size of inner code that is a power of 2. The size of the inner code may be referred to herein as a kernel size of the polar code.

Outer codes of the polar code of example 400 are illustrated by reference number 410. When the polar code of example 400 is implemented as a single polar code, there may be N outer codes of size 1. When the polar code is implemented as two inner codes, there may be N/2 outer codes of size 2. Generally, when a polar code is implemented with Z inner codes, there may be N/Z outer codes of size Z.

A polar code may exploit polarization of a channel to improve channel capacity. “Polarization” may refer to a phenomenon by which a given channel tends toward total reliability or total noise. For example, some channels may have a bit error rate approaching zero (indicating total reliability) and other channels may have a bit error rate approaching 0.5 (indicating total noise or no capacity). Each channel may correspond to a bit position, and the proportion of bit positions that occur on reliable channels to bit positions that occur on noisy channels may converge to the channel capacity. Given a channel capacity, indexes of N channels can be sorted according to bit error rate. To transmit using a rate R, an encoder may map information to a best K bit channels, where K/N=R. For remaining bits and channels (such as a remaining N−K bits or channels), the encoder may map fixed values known to a decoder. These fixed values are referred to as frozen bits.

In FIG. 4, two independent copies of W_{N/2} are combined to produce a channel W_{N}. The input vector

$${u}_{1}^{N}$$

to W_{N} is first transformed into

$${s}_{1}^{N}$$

so that s₂ᵢ₋₁=u₂ᵢ₋₁⊕u₂ᵢ and s₂ᵢ=u₂ᵢ for 1≤i≤N/2. The operator R_{N} in FIG. 4, denoted by reference number 412, is a permutation, such as the reverse shuffle operation, and may act on the input

$${s}_{1}^{N}$$

to produce

$${v}_{1}^{N} = ( {s}_{1} , {s}_{3} , … , {s}_{N - 1} , {s}_{2} , {s}_{4} , … , {s}_{N} ) ,$$

which becomes the input to the two copies of W_{N/2} as shown in FIG. 4.

The mapping of

$${u}_{1}^{N} to {x}_{1}^{N} ,$$

from the input of the synthesized channel W_{N} to the input of underlying raw channels W^{N}, is linear and may be represented by a matrix G_{N} so that

$${x}_{1}^{N} = {u}_{1}^{N} {G}_{N} .$$

G_{N} is referred to as the generator matrix and has a size N. The transition probabilities of the two channels W_{N} and W^{N} are related by

$${W}_{N} ( {y}_{1}^{N} \vert {u}_{1}^{N} ) = {W}^{N} ( {y}_{1}^{N} \vert {U}_{1}^{N} {G}_{N} ) for all {y}_{1}^{N} ∈ {Y}^{N} , {u}_{1}^{N} ∈ {X}^{N} .$$

G_{N} equals B_{N}F^{⊕n} for any N=2ⁿ, n≥0, where B_{N} is a permutation matrix such as a bit-reversal matrix and

$$F {=}^{△} [ \begin{matrix}1 & 0 \\ 1 & 1\end{matrix} ] .$$

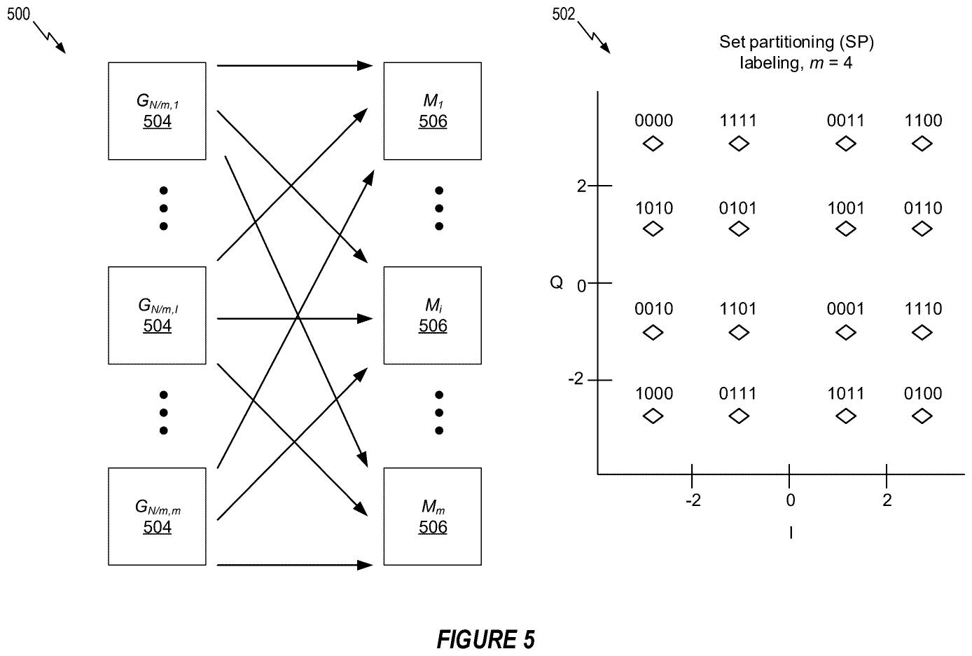

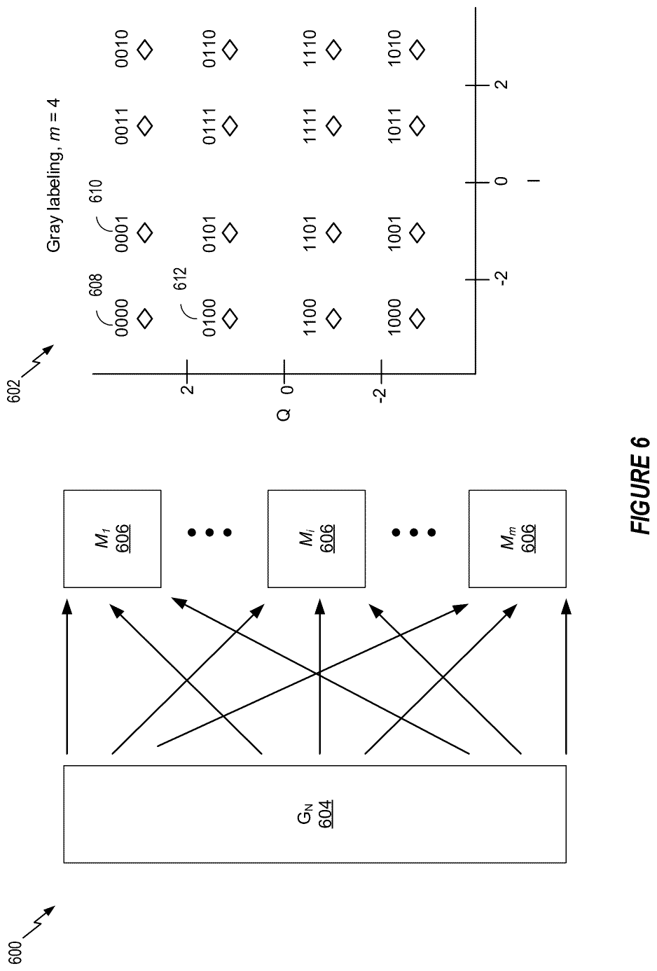

FIGS. 5 and 6 provide examples of implementation of polar codes using MLC and BICM. MLC and BICM are schemes for performing polar coding with higher-order modulation constellations, such as constellations involving 4-bit labelings (e.g., 16-QAM with an order of m=4), 6-bit labelings (e.g., 64-QAM with an order of m=6), or a labeling for another order of modulation constellation. Generally, FIGS. 5 and 6 are described for an order of m, with inner codes of size m.

FIG. 5 is a diagram illustrating an example 500 of MLC and a modulation constellation labeling 502 that is compatible with MLC. In MLC, m outer codes 504, each denoted G_{N/m} (shown as G_{N/m,1} through G_{N/m,m}) are implemented. Each outer code 504 (denoted G_{N/m,i}) may be connected to an ith bit of the modulation constellation, as indicated by constellation bit mapping blocks 506. For example, in the modulation constellation labeling 502, G_{N/m,1} may be mapped to a first (leftmost) bit corresponding to a constellation bit mapping block denoted M₁, G_{N/m,2} may be mapped to a second bit corresponding to a constellation bit mapping block denoted M₂ (not illustrated), G_{N/m,3} may be mapped to a third bit corresponding to a constellation bit mapping block denoted M₃ (not illustrated), and G_{N/m,4} may be mapped to a fourth (rightmost) bit corresponding to a constellation bit mapping block denoted M₄ (not illustrated).

MLC may be performed according to the architecture of FIG. 4. For example, an encoder (such as a transmitter) may obtain input information. The encoder may perform polar coding of the information according to the architecture of FIG. 4 and using the polar code illustrated in example 500 to obtain an output bit string (which is generated per bit of the modulation constellation, as mentioned). The encoder may map the output bit string to the modulation constellation labeling 502 via the constellation bit mapping blocks 506 to obtain a modulation symbol. Thus, MLC can be used to perform coded modulation using a polar code for higher modulation orders.

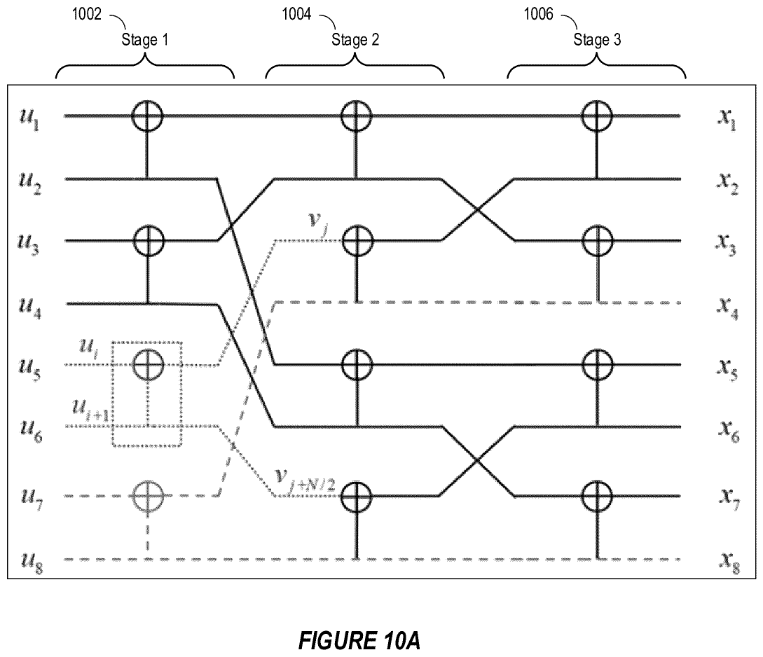

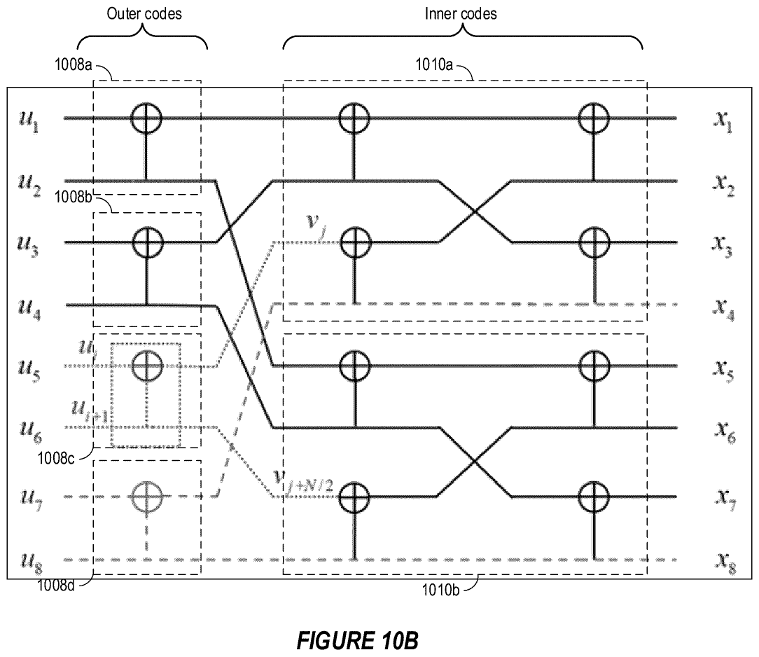

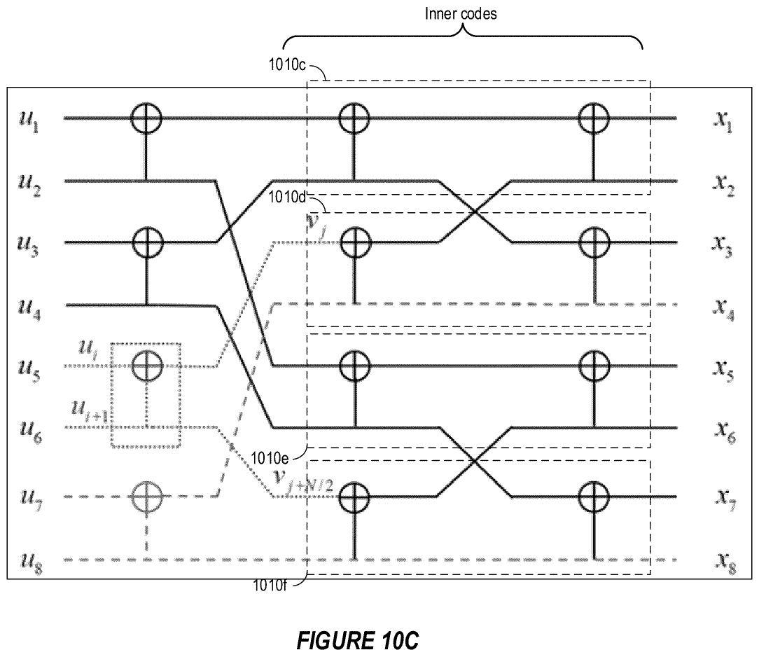

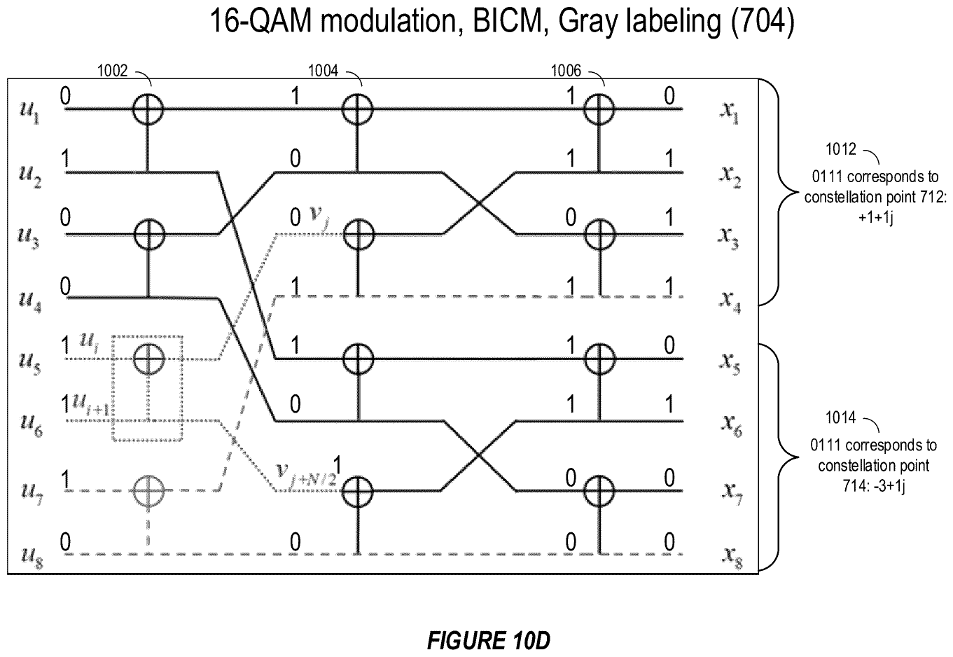

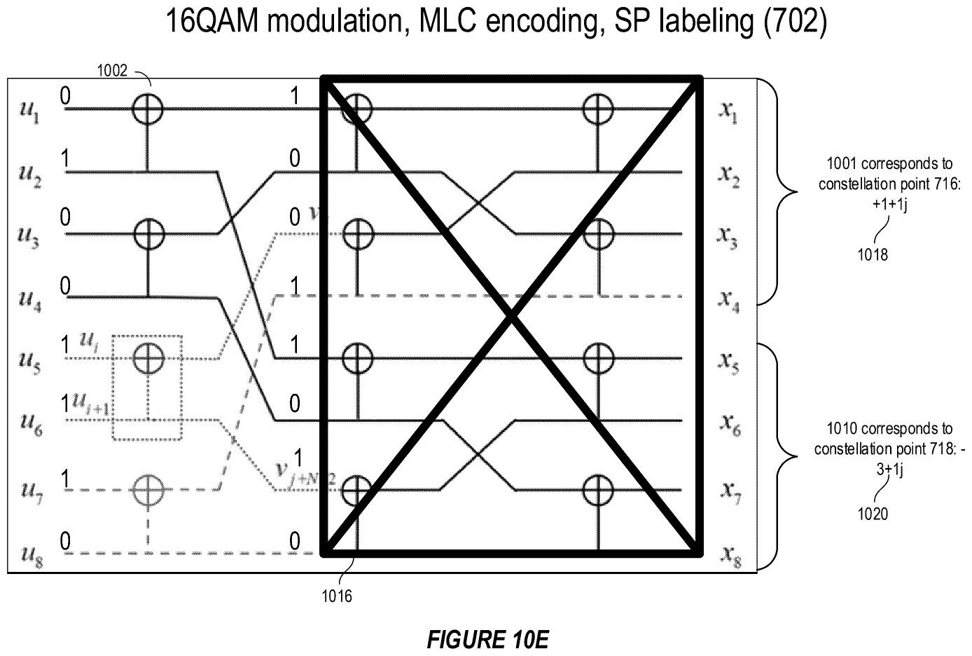

The modulation constellation labeling 502 may use a set partitioning (SP) labeling scheme. An SP labeling scheme may divide the modulation constellation into a set of mutually exclusive, collectively exhaustive subsets. The SP labeling scheme may be configured to maximize a Euclidean separation between nearest neighbors of a given subset. In some example, subsets may be defined according to bit positions of a labeling. Additional detail regarding MLC encoding is provided in connection with FIGS. 10A-10E.

FIG. 6 is a diagram illustrating an example 600 of BICM and a modulation constellation labeling 602 that is compatible with BICM. In a BICM scheme, a single outer code 604, denoted G_{N}, is used. An output of the single outer code 604 may be used for all bit positions i (where i takes values of 1 through m) of the modulation constellation labeling 602. Each bit position i may be associated with a constellation bit mapping block 606, denoted M₁ through Mₘ.

BICM may be performed according to the architecture of FIG. 4. For example, an encoder (such as a transmitter) may obtain input information. The encoder may perform polar coding of the information according to the architecture of FIG. 4 and using the polar code illustrated in example 600 to obtain an output bit string (which is generated for all bit positions of the modulation constellation, as mentioned). The encoder may map the output bit string to the modulation constellation labeling 602 via the constellation bit mapping blocks 606 to obtain a modulation symbol. Thus, BICM can be used to perform coded modulation using a polar code for higher modulation orders.

The modulation constellation labeling 602 may use a Gray labeling scheme. A Gray labeling scheme for a modulation constellation provides a labeling where any two points that are nearest neighbors (in terms of distance from one another) have binary labels that differ in exactly one bit position. For example, label 608 differs from each of label 610 and label 612 by exactly one bit position. Additional detail regarding BICM encoding is provided in connection with FIGS. 10A-10E.

MLC, as described with regard to FIG. 5, may provide a threshold performance (e.g., optimal performance). In particular, MLC may provide a larger performance gain for larger constellations than for smaller constellations. However, MLC may be associated with a higher level of complexity than BICM due to a recursive de-mapping process. For example, when decoding a symbol generated using MLC, a decoder/receiver may generate log likelihood ratios (LLRs) for each outer code given previously decoded bits of the symbol, which increases complexity relative to other schemes such as BICM. Furthermore, MLC and BICM may use different sets of frozen bits.

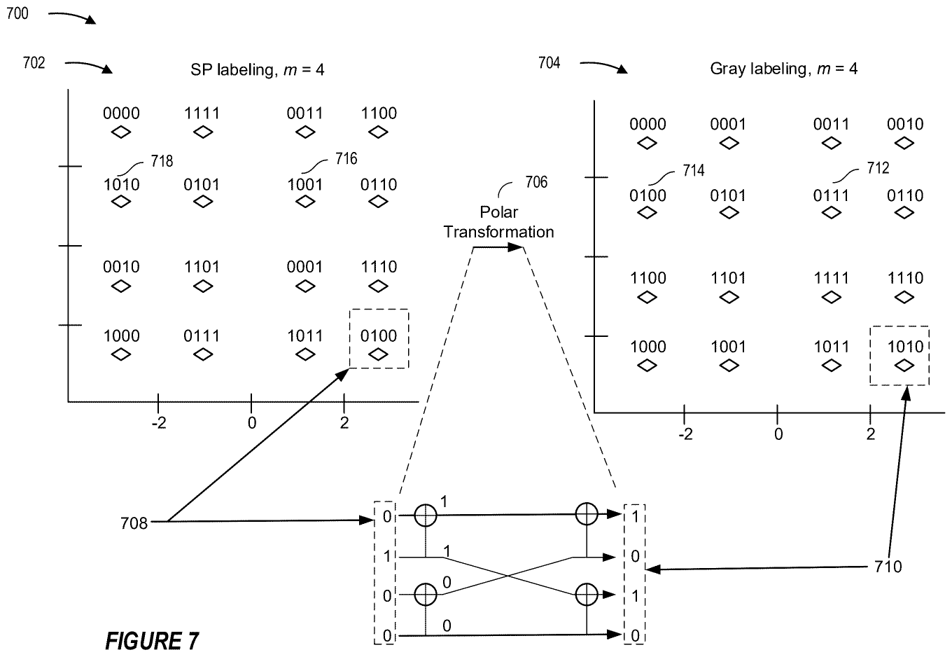

FIG. 7 is a diagram illustrating an example 700 of polar transformation of a modulation constellation labeling 702. In example 700, the modulation constellation labeling 702 is an SP labeling, such as the modulation constellation labeling 502 of FIG. 5. A polar-transformed labeling 704 is generated by applying a polar transformation 706 to the modulation constellation labeling 702. Both the polar-transformed labeling 704 and the modulation constellation labeling 702 have an order of m=4. The polar transformation 706 is an example polar transformation, and has a size of m=4. Thus, the polar transformation 706 uses a polar code with a same size as an order of the modulation constellation labeling 702 (and the polar-transformed labeling 704).

In some aspects, “polar transformation” may refer to an inverse polar transformation. For example, the modulation constellation labeling 702 can be obtained by applying a polar transformation that is an inverse polar transformation to the polar-transformed labeling 704.

As shown, an input label 708 is processed according to the polar transformation 706 to determine an output label 710. By defining output labels in this fashion, aspects described herein enable MLC to be implemented using BICM polar coding. For example, encoding a polar code in a BICM scheme with the polar-transformed labeling 704 from encoding the modulation constellation labeling 702 (which in this example is an SP labeling) with a size m polar code may be equivalent (on a bit-by-bit basis) to encoding using a polar code in an MLC scheme with the modulation constellation labeling 702.

Thus, the MLC encoder may be implemented as a BICM encoder without the last log ₂(m) stages, where the last log ₂(m) stages are a polar code of size m. For example, for 16-QAM (m=4), the MLC encoder may be similar to a BICM encoder without the last 2 stages which are a polar code of size 4. In this example, since a polar code of size m is a linear reversible transformation, using the polar-transformed labeling 704 with the BICM encoder is equivalent to skipping the last log ₂(m) stages.

In example 700, the modulation constellation labeling 702 is an SP labeling. The techniques of example 700 can be applied for other forms of labeling. For example, the techniques of example 700 can be applied for a Gray labeling such as the modulation constellation labeling 602. For example, a polar transformation 706 may be applied to a first Gray labeling to obtain a second, polar-transformed labeling. In this example, the first Gray labeling may be associated with a first set of frozen bits and the second, polar-transformed labeling may be associated with a second set of frozen bits.

In some aspects, a modulation constellation labeling (sometimes referred to as a labeling scheme) may be associated with a frozen bit configuration. A frozen bit configuration may indicate which bit positions (e.g., channels) carry frozen bits. These bit positions may be associated with a high symbol error rate, a high bit error rate, low mutual information, or the like. In some aspects, a given encoding scheme may be implemented with a given frozen bit configuration, irrespective of whether the encoding scheme is implement directly or by performing a second encoding scheme with a polar-transformed labeling. For example, a transmitter that encodes input information using BICM polar coding with the polar-transformed labeling 704, and a transmitter that encodes the input information using MLC polar coding with the modulation constellation labeling 702, may use the same set of frozen bits to perform the encoding. A receiver may decode the transmission using frozen bits associated with MLC polar coding with the modulation constellation labeling 702, irrespective of whether the transmission was encoded with BICM and the polar-transformed labeling 704 or the MLC polar coding with the modulation constellation labeling 702.

Certain constellation points are indicated by reference numbers 712, 714, 716, and 718. These constellation points are used to facilitate explanation of FIGS. 11A-11E elsewhere herein.

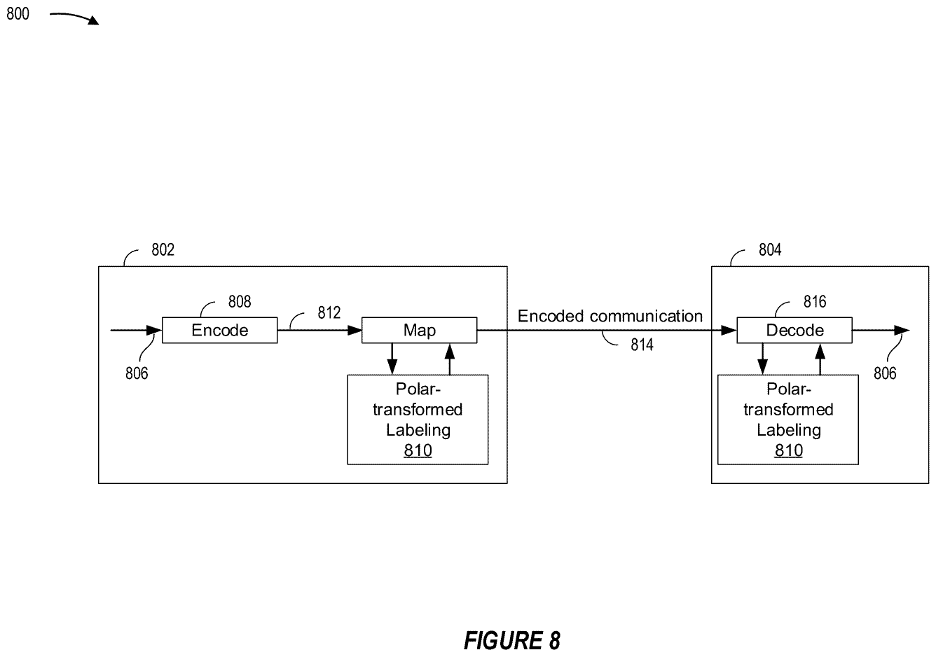

FIG. 8 is a diagram illustrating an example 800 of encoding and decoding with a polar-transformed labeling. Example 800 includes a transmitter 802, which may include a UE 120, a network entity 110, a UE 304, a network entity 300, or a network entity 302. Example 800 also includes a receiver 804, which may include a UE 120, a network entity 110, a UE 304, a network entity 300, or a network entity 302.

As shown in FIG. 8, the transmitter may obtain input information 806. The input information 806 may include any form of data. In some aspects, the transmitter may divide the input information 806 according to a modulation order. For example, for an order of m=4, the transmitter may obtain a number of 4-bit segments of the input information 806.

As shown, the transmitter may perform encoding 808 using a polar code and a polar-transformed labeling 810. The polar-transformed labeling 810 may be an example of polar-transformed labeling 704. Generally, a polar-transformed labeling 810 may include a modulation constellation labeling that is generated or can be generated by applying a polar transformation (such as polar transformation 706) to another modulation constellation labeling. In some aspects, the polar-transformed labeling 810 may be derived from an SP labeling. In some aspects, the polar-transformed labeling 810 may be derived from a Gray labeling. In some aspects, by applying the inverse of the polar transformation used to generate the polar-transformed labeling 810, an original modulation constellation labeling (from which the polar-transformed labeling was derived) can be obtained. For example, if the polar-transformed labeling 810 is derived from an SP labeling, an inverse polar transformation may result in the SP labeling.

The encoding 808 may be based on a set of frozen bits. For example, the encoding 808 may be based on a frozen bit configuration that indicates the set of frozen bits. In some aspects, the set of frozen bits may be associated with the polar-transformed labeling 810. For example, different polar-transformed labelings may be associated with different sets of frozen bits. Additionally or alternatively, the set of frozen bits may be associated with the encoding 808. For example, the set of frozen bits may be specific to whether the encoding 808 is MLC polar coding or BICM polar coding (that is, a first set of frozen bits may be used for MLC polar coding with the polar-transformed labeling 810 or a second set of frozen bits may be used for BICM polar coding with the polar-transformed labeling 810).

In some aspects, the encoding 808 may be BICM polar coding. The polar-transformed labeling 810 may be derived from (for example, generated by applying a polar transformation to) an SP labeling. For example, the polar-transformed labeling 810 may be an example of polar-transformed labeling 704. Thus, MLC encoding can be implemented at an encoder that supports BICM polar coding. The encoding 808 may map a set of K information bits to high-reliability positions (such as non-frozen bit positions) and may map N—K frozen bit values to positions indicated by a set of frozen bits. The set of frozen bits may be associated with (e.g., correspond to) the BICM polar coding, the polar-transformed labeling 810, or both.

As another example where the encoding 808 is BICM polar coding, the polar-transformed labeling 810 may be derived from (for example, generated by applying a polar transformation 706 to) a Gray labeling. The encoding 808 may map a set of K information bits to high-reliability positions (such as non-frozen bit positions) and may map N—K frozen bit values to positions indicated by a set of frozen bits. The set of frozen bits may be associated with (e.g., correspond to) the BICM polar coding, the polar-transformed labeling 810, or both.

As shown, the encoding 808 may provide an output 812. For example, the output 812 may include a set of bits. The transmitter 802 may map the output 812 to the polar-transformed labeling 810 to obtain an encoded communication 814. For example, the transmitter 802 may identify a constellation point that is mapped to the set of bits of the output 812, and may generate a modulation symbol corresponding to the constellation point.

The transmitter 802 may transmit the encoded communication 814. For example, the transmitter 802 may obtain one or more modulation symbols by mapping the output 812 to the polar-transformed labeling 810, and may transmit the one or more modulation symbols.

The receiver 804 may receive the encoded communication 814. The receiver 804 may perform decoding 816 of the encoded communication 814. The decoding 816 may include successive cancellation (SC) decoding, SC list (SCL) decoding, or another form of decoding. In some aspects, the decoding 816 may correspond to the encoding 808. For example, the decoding 816 may use an MLC decoder if the encoding 808 uses BICM with a polar-transformed labeling 810 derived from an SP labeling, which improves performance relative to BICM decoding. Thus, BICM with a polar-transformed labeling 810 derived from an SP labeling may be equivalent to MLC encoding with the SP labeling. As another example, the decoding 816 may use a BICM decoder if the encoding 808 uses MLC with a labeling that can be derived from an inverse polar transformation of the polar-transformed labeling 810. As another example, the decoding 816 may use a BICM decoder if the encoding 808 uses BICM with a polar-transformed labeling 810 derived from a Gray labeling. The decoding 816 may output the input information 806. As mentioned, the decoding 816 may be based on the set of frozen bits. For example, the decoding 816 may use, as an input, the set of frozen bits to decode the encoded communication 814.

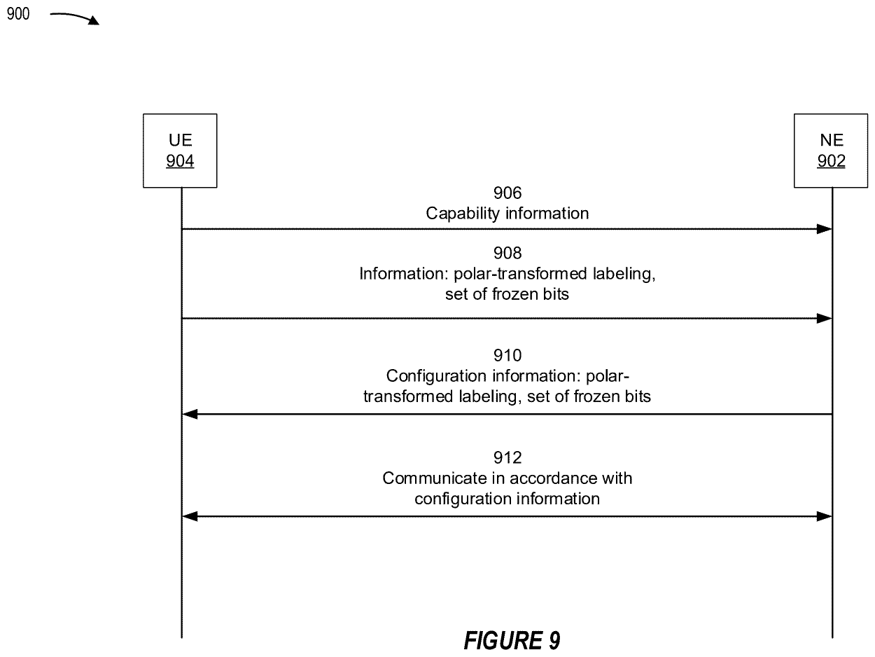

FIG. 9 is a diagram illustrating an example 900 of signaling between a UE and a network entity related to transparent polar coding implementation. Example 900 includes a network entity 902 and a UE 904. The network entity 902 may be an example of a network entity 110, a network entity 300, a network entity 302, a transmitter, or a receiver. The UE 904 may be an example of a UE 120, a UE 304, a transmitter, or a receiver.

As shown, the UE 904 may transmit, and the network entity 902 may receive, capability information 906. For example, the UE 904 may transmit the capability information 906 via UE capability signaling or another form of signaling.

In some aspects, the capability information 906 may indicate support for one or more configurations. For example, the capability information 906 may indicate one or more supported polar-transformed labeling schemes, one or more supported frozen bit configurations (such as one or more supported sets of frozen bits), or a combination thereof. For example, the capability information 906 may include a value that corresponds to one or more of a polar-transformed labeling scheme or a set of frozen bits. These polar-transformed labeling schemes may include, for example, a polar-transformed SP labeling scheme (such as for an MLC scheme implemented using BICM), a polar-transformed Gray labeling scheme (such as for a BICM scheme), a modified (such as optimized) Gray labeling scheme, or another polar-transformed labeling scheme. The set of frozen bits may correspond to the indicated polar-transformed labeling scheme and/or a polar coding scheme (such as BICM or MLC) to be used to decode a communication using the polar-transformed labeling scheme.

As shown, the UE 904 may transmit, and the network entity 902 may receive, information 908 that indicates a polar-transformed labeling, a set of frozen bits, or a combination thereof. For example, the UE 904 may select or generate the polar-transformed labeling and/or the set of frozen bits. The UE 904 may transmit information indicating the polar-transformed labeling and/or the set of frozen bits via any suitable form of signaling.

As shown, the network entity 902 may transmit, and the UE 904 may receive, configuration information 910. The configuration information 910 may include a configuration associated with encoding or decoding a communication using polar coding (such as MLC or BICM polar coding) and a polar-transformed labeling. For example, the configuration information 910 may indicate the polar-transformed labeling. Additionally or alternatively, the configuration information 910 may indicate a set of frozen bits for the polar coding. Additionally, or alternatively, the configuration information 910 may indicate whether the UE 904 or the network entity 902 is to perform BICM polar coding or MLC polar coding. For example, the configuration information 910 may include an index into a table that indicates one or more of a polar-transformed labeling, a set of frozen bits, or whether the UE 904 is to perform BICM polar coding or MLC polar coding.

The network entity 902 may transmit the configuration information 910 via any suitable form of signaling, such as radio resource control signaling, medium access control signaling, or downlink control information. Transmitting the configuration information 910 via downlink control information may enable rapid reconfiguration, such as per-slot reconfiguration, of the polar coding.

In some aspects, the polar-transformed labeling may be defined by a polar-transformed labeling scheme indicated by the capability information 906 or the information 908. For example, the network entity 902 may configure a polar-transformed labeling and/or polar coding (such as a set of frozen bits) in accordance with the capability information 906 or the information 908.

In some aspects, the configuration information 910 may be specific to a code block. For example, the configuration information 910 may indicate a polar-transformed labeling, set of frozen bits, and/or polar coding scheme for a code block or set of code blocks (that is, the configuration information 910 may be per code block). In some aspects, the configuration information 910 may be specific to a code block group. For example, the configuration information 910 may indicate a polar-transformed labeling, set of frozen bits, and/or polar coding scheme for a code block group or set of code block groups (that is, the configuration information 910 may be per code block group). In some aspects, the configuration information 910 may be specific to a slot. For example, the configuration information 910 may indicate a polar-transformed labeling, set of frozen bits, and/or polar coding scheme for a slot or set of slots (that is, the configuration information 910 may be per slot).

As shown, in an operation 912, the network entity 902 and the UE 904 may communicate in accordance with the configuration information 910. For example, a transmitter (such as the network entity 902 or the UE 904) may encode a communication, such as a physical downlink shared channel communication or a physical uplink shared channel configuration, according to operations described with regard to the transmitter 802 of FIG. 8. A receiver (such as the UE 904 or the network entity 902) may decode the communication according to operations described with regard to the receiver 804 of FIG. 8. If the configuration information 910 is specific to a slot, the network entity 902 and the UE 904 may communicate in accordance with the configuration information 910 in the slot. If the configuration information 910 is specific to a code block, the network entity 902 and the UE 904 may transmit or receive the code block in accordance with the configuration information 910. If the configuration information 910 is specific to a code block group, the network entity 902 and the UE 904 may communicate in accordance with the configuration information 910 in the code block group.

Thus, the UE 904 and/or the network entity 902 can switch between implementing MLC (such as using a polar-transformed SP labeling) or BICM (such as using a Gray labeling, which may be a polar-transformed Gray labeling). For example, the UE 904 and/or the network entity 902 can switch between In this way, MLC and BICM can both be implemented using similar transmit procedures and the same hardware.

FIGS. 10A-10E are diagrams illustrating examples of polar encoding with BICM and MLC. FIGS. 10A-10E provide detail regarding how to implement BICM encoding with 16QAM modulation, MLC encoding with 16QAM modulation, and BICM encoding using an MLC encoder (and vice versa). FIGS. 10A-10E relate to a polar code with length N=8. This polar code has log ₂(N)=3 stages: a first stage 1002, a second stage 1004, and a third stage 1006.

FIGS. 10B and 10C illustrate that a polar code can be divided into inner codes 1008 and outer codes 1010 in a variety of ways. In FIG. 10B, there are four outer codes 1008a, 1008b, 1008c, 1008d, each having a size of 2. There are also two inner codes 1010a and 1010b, each having a size of 4. In FIG. 10C, there are four inner codes 1010c, 1010d, 1010c, and 1010f, each having a size of 2. Outer codes 1008 are not illustrated in FIG. 10C.

FIG. 10D illustrates an example of 16-QAM modulation with BICM encoding. In FIG. 10D, an output of the size-8 polar code is mapped to a Gray labeled constellation with order m=4 (for 16-QAM). Notably, the polar-transformed labeling 704 of FIG. 7 is an example of a Gray labeled constellation. In FIG. 10D, an input of 01001110 is encoded. After the first stage 1002, the input has been transformed to 10011010. After the second stage 1004, the input has been transformed to 10011100. After the third stage 1006, the input has been transformed to the output of 01110100. The output includes eight bits. As indicated by reference number 1012, a first four bits can be mapped to constellation point 712 of the Gray labeled constellation (that is, the polar-transformed labeling 704) to obtain a symbol value +1+1j. As indicated by reference number 1014, a last four bits can be mapped to constellation point 714 of the Gray labeled constellation (that is, the polar-transformed labeling 704) to obtain a symbol value −3+1j.

FIG. 10E illustrates an example of 16-QAM modulation with MLC encoding. As indicated by reference number 1016, in MLC encoding, a final log ₂(m) stages of the polar code (that is, the second stage 1004 and the third stage 1006) can be skipped. As in FIG. 10D, after the first stage 1002, the input has been transformed to 10011010. As indicated by reference number 1018, a first four bits can be mapped to constellation point 716 of an SP labeled constellation to obtain a symbol value +1+1j. As indicated by reference number 1020, a last four bits can be mapped to constellation point 718 of the SP labeled constellation to obtain a symbol value −3+1j.

Note that the symbol values obtained in FIG. 10D and FIG. 10E are the same as one another. For example, the values indicated by reference numbers 1012 and 1018 are the same as one another, and the values indicated by reference numbers 1014 and 1020 are the same as one another. This may be based on the Gray labeling (that is, the polar-transformed labeling 704) of FIG. 10D being obtainable by performing a polar transformation 706 on the modulation constellation labeling 702 (which is an SP labeling). Thus, MLC encoding with a first constellation labeling may lead to the same modulation result as BICM encoding with a second constellation labeling that is derived from performing a polar transformation of the first constellation labeling. While in FIGS. 7 and 10A-10E, the first constellation labeling is an SP labeling and the second constellation is a Gray labeling, this property may hold for any second constellation labeling that is derived from a polar transformation of the first constellation labeling.

As described above, a BICM encoder may implement BICM encoding as illustrated in FIG. 10D, and an MLC encoder may implement MLC encoding as illustrated in FIG. 10E. However, as described elsewhere herein and below, a BICM encoder (illustrated in FIG. 10D) can also implement MLC encoding, and an MLC encoder (illustrated in FIG. 10E) can also implement BICM encoding. A decoder may be able to decode a communication that was encoded by a BICM encoder that implements MLC encoding by using an MLC decoder with a labeling and set of frozen bits specific to MLC encoding. Similarly, a decoder may be able to decode a communication that was encoded by an MLC encoder that implements BICM encoding by using a BICM decoder with a labeling and set of frozen bits specific to BICM decoding.

A description of implementing MLC encoding using a BICM encoder is now provided with reference to FIG. 10D. As described, the BICM encoder may receive, as input, the input 01001110. The BICM encoder may perform the first stage 1002, second stage 1004, and third stage 1006 of encoding using a set of frozen bits specific to implementing MLC encoding using a BICM encoder. The output may be mapped to a labeling that is a polar transformation of an SP labeling. An example of such a labeling is the polar-transformed labeling 704, which is derived from a polar transformation 706 of the modulation constellation labeling 702. A receiver can demodulate and decode the output using the labeling that is derived from the polar transformation of the SP labeling, and the set of frozen bits.

A description of implementing BICM encoding using an MLC encoder is now provided with reference to FIG. 10E. As described, the MLC encoder may receive, as input, the input 01001110. The BICM encoder may perform a first stage 1002 of encoding using a set of frozen bits specific to implementing BICM encoding using an MLC encoder. The output of the first stage 1002 may be mapped to a labeling that is derived from a polar transformation (in this case, an inverse polar transformation) of a Gray labeling. An example of such a labeling is the modulation constellation labeling 702. A receiver can demodulate and decode the output using the labeling that is derived from the inverse polar transformation of the Gray labeling, and the set of frozen bits.

FIG. 11 shows a process 1100 for wireless communications by a transmitter, such as UE 120 of FIG. 1 or UE 304 of FIG. 3.

Process 1100 begins at block 1105 with encoding information, using polar coding and a polar-transformed labeling, to obtain encoded information, wherein the polar-transformed labeling is according to a polar transformation or an inverse polar transformation of a labeling scheme.

Process 1100 then proceeds to block 1110 with transmitting the encoded information.

In some aspects, block 1105 includes encoding the information based on a set of frozen bits that are derived from the polar-transformed labeling.

In some aspects, block 1105 includes encoding the information using BICM encoding.

In some aspects, the labeling scheme is a set partitioning labeling scheme prior to the polar transformation, wherein the polar transformation uses a polar code of a size m and the set partitioning labeling scheme has an order of m.

In some aspects, block 1105 includes encoding the information based on a set of frozen bits associated with the multi-level coding.

In some aspects, encoding the information using BICM and the polar-transformed labeling is equivalent to encoding the information using multi-level coding and the set partitioning labeling scheme.

In some aspects, block 1105 includes encoding the information using multi-level coding.

In some aspects, the labeling scheme is a Gray labeling scheme prior to the inverse polar transformation, wherein the inverse polar transformation uses an inverse polar code of a size m and the Gray labeling scheme has an order of m.

In some aspects, block 1105 includes encoding the information based on a set of frozen bits associated with the Gray labeling scheme.

In some aspects, encoding the information using multi-level coding and the polar-transformed labeling is equivalent to encoding the information using BICM and the Gray labeling scheme.

In some aspects, process 1100 includes selecting the polar-transformed labeling in accordance with whether the polar coding uses bit-interleaved coded modulation or multi-level coding.

In some aspects, process 1100 includes transmitting an indication of the polar-transformed labeling.

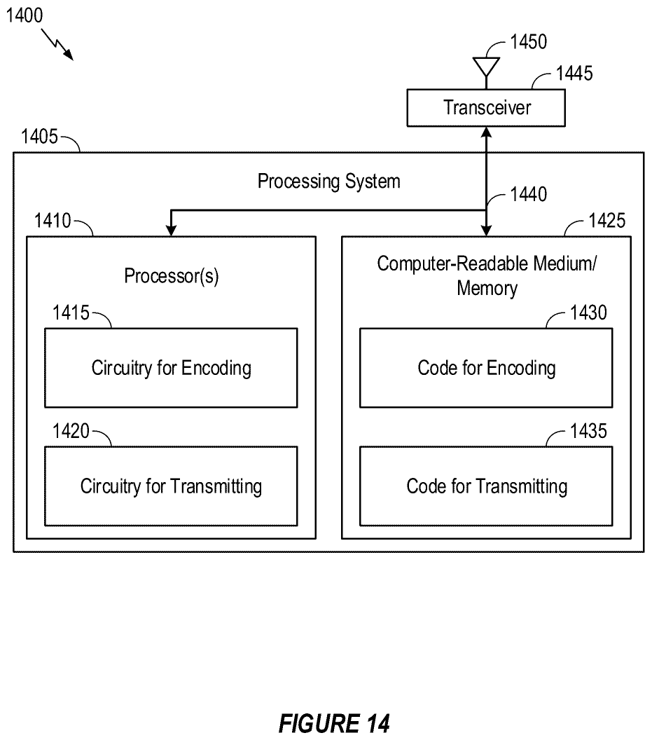

In some aspect, process 1100, or any aspect related to it, may be performed by an apparatus, such as communications device 1400 of FIG. 14, which includes various components operable, configured, or adapted to perform the process 1100. Communications device 1400 is described below in further detail.

Note that FIG. 11 is just one example of a method, and other methods including fewer, additional, or alternative operations are possible consistent with this disclosure.

FIG. 12 shows a process 1200 for wireless communications by a user equipment (UE), such as UE 120 of FIG. 1 or UE 304 of FIG. 3.

Process 1200 begins at block 1205 with transmitting or receiving a configuration associated with encoding or decoding a communication using polar coding and a polar-transformed labeling.

Process 1200 then proceeds to block 1210 with performing the communication according to the configuration.

In some aspects, the configuration indicates a set of frozen bits associated with the polar-transformed labeling.

In some aspects, the configuration indicates the polar-transformed labeling.

In some aspects, process 1200 further includes transmitting capability information that indicates support for one or more configurations, wherein the configuration is one of the one or more configurations, and wherein block 1205 includes receiving the configuration.

In some aspects, the capability information indicates support for one or more polar-transformed labelings, one or more sets of frozen bits, or a combination thereof.

In some aspects, block 1205 includes transmitting the configuration.

In some aspects, the configuration is at least one of: a radio resource control configuration, a medium access control configuration, or a downlink control information configuration.

In some aspects, the communication comprises a code block and the configuration is specific to the code block.

In some aspects, the communication comprises a code block group and the configuration is specific to the code block group.

In some aspects, the communication occurs in a slot and the configuration is specific to the slot.

In some aspects, block 1210 includes: encoding input information using the polar coding and the polar-transformed labeling, according to the configuration, to obtain encoded information; and transmitting the encoded information as the communication.

In some aspects, the polar coding is BICM polar coding and the polar-transformed labeling is based on a polar transformation of a set partitioning labeling scheme, wherein the polar transformation uses a polar code of a size m and the set partitioning labeling scheme has an order of m.

In some aspects, the polar coding is MLC polar coding and the polar-transformed labeling is based on a polar transformation of a Gray labeling scheme, wherein the polar transformation uses a polar code of a size m and the set partitioning labeling scheme has an order of m.

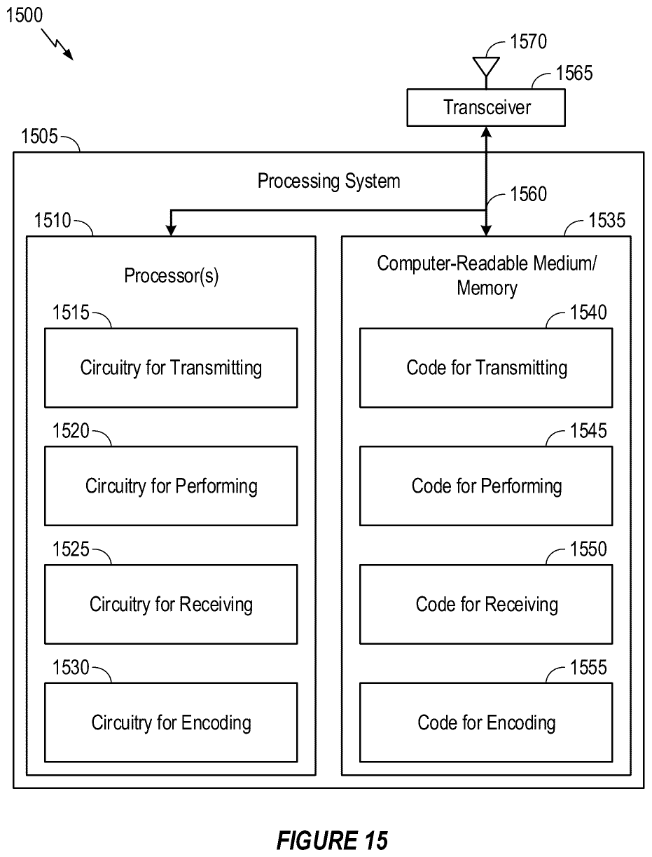

In some aspect, process 1200, or any aspect related to it, may be performed by an apparatus, such as communications device 1500 of FIG. 15, which includes various components operable, configured, or adapted to perform the process 1200. Communications device 1500 is described below in further detail.

Note that FIG. 12 is just one example of a method, and other methods including fewer, additional, or alternative operations are possible consistent with this disclosure.

FIG. 13 shows a process 1300 for wireless communications by a network entity, such as network entity 110 of FIG. 1, a first network entity 300 or second network entity 302 of FIG. 3, or a disaggregated base station as discussed with respect to FIG. 2.

Process 1300 begins at block 1305 with transmitting or receiving a configuration associated with encoding or decoding a communication using polar coding and a polar-transformed labeling.

Process 1300 then proceeds to block 1310 with performing the communication according to the configuration.

In some aspects, the configuration indicates a set of frozen bits associated with the polar-transformed labeling.

In some aspects, the configuration indicates the polar-transformed labeling.

In certain aspects, process 1300 further includes receiving capability information that indicates support for one or more configurations, wherein the configuration is one of the one or more configurations, and wherein block 1305 includes transmitting the configuration.

In some aspects, the capability information indicates support for one or more polar-transformed labelings, one or more sets of frozen bits, or a combination thereof.

In some aspects, block 1305 includes receiving the configuration.

In some aspects, the configuration is at least one of: a radio resource control configuration, a medium access control configuration, or a downlink control information configuration.

In some aspects, the communication comprises a code block and the configuration is specific to the code block.

In some aspects, the communication comprises a code block group and the configuration is specific to the code block group.

In some aspects, the communication occurs in a slot and the configuration is specific to the slot.

In some aspects, block 1310 includes: encoding input information using the polar coding and the polar-transformed labeling, according to the configuration, to obtain encoded information; and transmitting the encoded information as the communication.

In some aspects, the polar coding is BICM polar coding and the polar-transformed labeling is based on a polar transformation of a set partitioning labeling scheme, wherein the polar transformation uses a polar code of a size m and the set partitioning labeling scheme has an order of m.

In some aspects, the polar coding is MLC polar coding and the polar-transformed labeling is based on a polar transformation of a Gray labeling scheme, wherein the polar transformation uses a polar code of a size m and the set partitioning labeling scheme has an order of m.

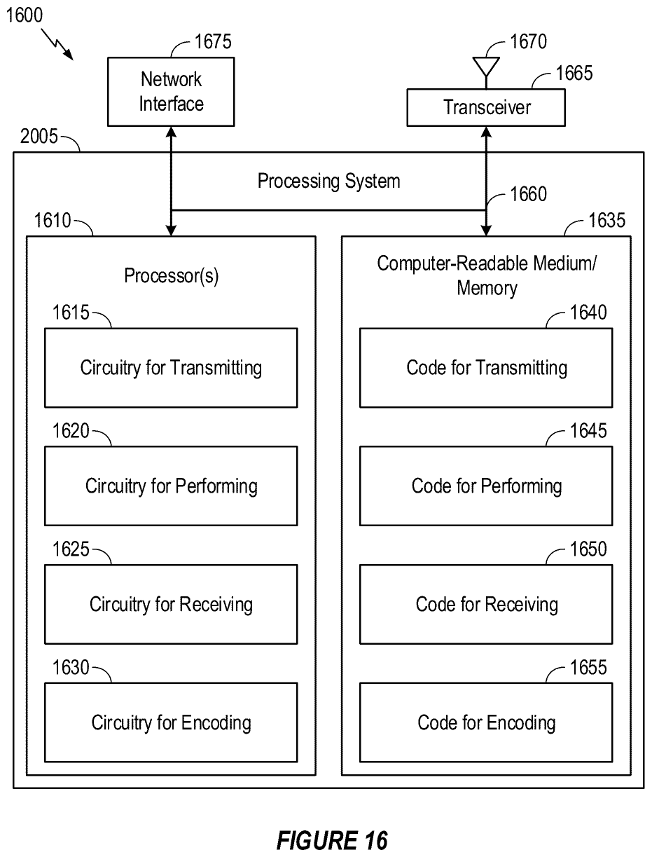

In some aspect, process 1300, or any aspect related to it, may be performed by an apparatus, such as communications device 1600 of FIG. 16, which includes various components operable, configured, or adapted to perform the process 1300. Communications device 1600 is described below in further detail.

Note that FIG. 13 is just one example of a method, and other methods including fewer, additional, or alternative operations are possible consistent with this disclosure.

FIG. 14 depicts aspects of an example communications device 1400 configured for wireless communications. In some aspects, communications device 1400 is a user equipment, such as UE 120 described above with respect to FIG. 1 or UE 304 described with respect to FIG. 3.

The communications device 1400 includes a processing system 1405 coupled to a transceiver 1445 (e.g., a transmitter and/or a receiver). The transceiver 1445 is configured to transmit and receive signals for the communications device 1400 via an antenna 1450, such as the various signals as described herein. The processing system 1405 may be configured to perform processing functions for the communications device 1400, including processing signals received and/or to be transmitted by the communications device 1400.

The processing system 1405 includes one or more processors 1410 and a computer-readable medium/memory 1425. In various aspects, the one or more processors 1410 may be representative of the one or more processors 318 described with respect to FIG. 3. The one or more processors 1410 are coupled to a computer-readable medium/memory 1425 via a bus 1440. In some aspects, the computer-readable medium/memory 1425 may be representative of the one or more memories 320 described with respect to FIG. 3. The computer-readable medium/memory 1425 is a non-transitory computer-readable medium/memory. In certain aspects, the computer-readable medium/memory 1425 is configured to store instructions (e.g., computer-executable code), that when executed by the one or more processors 1410, cause the one or more processors 1410 to perform the process 1100 described with respect to FIG. 11, or any aspect related to it, including any operations described in relation to FIG. 11. Note that reference to a processor performing a function of communications device 1400 may include one or more processors performing that function of communications device 1400, such as in a distributed fashion.

In the depicted example, computer-readable medium/memory 1425 stores code (e.g., executable instructions), including code for encoding 1430 and code for transmitting 1435. Processing of the code 1430 and 1435 may enable and cause the communications device 1400 to perform the process 1100 described with respect to FIG. 11, or any aspect related to it.

The one or more processors 1410 include circuitry configured to implement (e.g., execute) the code stored in the computer-readable medium/memory 1425, including circuitry for encoding 1415 and circuitry for transmitting 1420. Processing with circuitry 1415 and 1420 may enable and cause the communications device 1400 to perform the process 1100 described with respect to FIG. 11, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1445 and/or antenna 1450 of the communications device 1400 in FIG. 14, and/or one or more processors 1410 of the communications device 1400 in FIG. 14. Means for communicating, receiving or obtaining may include the one or more transceivers 324, one or more antennas 322, and/or processing system 316 of the UE 304 illustrated in FIG. 3, transceiver 1445 and/or antenna 1450 of the communications device 1400 in FIG. 14, and/or one or more processors 1410 of the communications device 1400 in FIG. 14.

FIG. 15 depicts aspects of an example communications device 1500 configured for wireless communications. In some aspects, communications device 1500 is a user equipment, such as UE 120 described above with respect to FIG. 1 or UE 304 described with respect to FIG. 3.

The communications device 1500 includes a processing system 1505 coupled to a transceiver 1565 (e.g., a transmitter and/or a receiver). The transceiver 1565 is configured to transmit and receive signals for the communications device 1500 via an antenna 1570, such as the various signals as described herein. The processing system 1505 may be configured to perform processing functions for the communications device 1500, including processing signals received and/or to be transmitted by the communications device 1500.

The processing system 1505 includes one or more processors 1510 and a computer-readable medium/memory 1535. In various aspects, the one or more processors 1510 may be representative of the one or more processors 318 described with respect to FIG. 3. The one or more processors 1510 are coupled to a computer-readable medium/memory 1535 via a bus 1560. In some aspects, the computer-readable medium/memory 1535 may be representative of the one or more memories 320 described with respect to FIG. 3. The computer-readable medium/memory 1535 is a non-transitory computer-readable medium/memory. In certain aspects, the computer-readable medium/memory 1535 is configured to store instructions (e.g., computer-executable code), that when executed by the one or more processors 1510, cause the one or more processors 1510 to perform the process 1200 described with respect to FIG. 12, or any aspect related to it, including any operations described in relation to FIG. 12. Note that reference to a processor performing a function of communications device 1500 may include one or more processors performing that function of communications device 1500, such as in a distributed fashion.

In the depicted example, computer-readable medium/memory 1535 stores code (e.g., executable instructions), including code for transmitting 1540, code for performing 1545, code for receiving 1550, and code for encoding 1555. Processing of the code 1540-1555 may enable and cause the communications device 1500 to perform the process 1200 described with respect to FIG. 12, or any aspect related to it.

The one or more processors 1510 include circuitry configured to implement (e.g., execute) the code stored in the computer-readable medium/memory 1535, including circuitry for transmitting 1515, circuitry for performing 1520, circuitry for receiving 1525, and circuitry for encoding 1530. Processing with circuitry 1515-1530 may enable and cause the communications device 1500 to perform the process 1200 described with respect to FIG. 12, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1565 and/or antenna 1570 of the communications device 1500 in FIG. 15, and/or one or more processors 1510 of the communications device 1500 in FIG. 15. Means for communicating, receiving or obtaining may include the one or more transceivers 324, one or more antennas 322, and/or processing system 316 of the UE 304 illustrated in FIG. 3, transceiver 1565 and/or antenna 1570 of the communications device 1500 in FIG. 15, and/or one or more processors 1510 of the communications device 1500 in FIG. 15.

FIG. 16 depicts aspects of an example communications device configured for wireless communications. In some aspects, communications device 1600 is a network entity, such as network entity 110 of FIG. 1, first network entity 300 or second network entity 302 of FIG. 3, or a disaggregated base station as discussed with respect to FIG. 2.

The communications device 1600 includes a processing system 1605 coupled to a transceiver 1665 (e.g., a transmitter and/or a receiver) and/or a network interface 1675. The transceiver 1665 is configured to transmit and receive signals for the communications device 1600 via an antenna 1670, such as the various signals as described herein. The network interface 1675 is configured to obtain and send signals for the communications device 1600 via communications link(s), such as a backhaul link, midhaul link, and/or fronthaul link as described herein, such as with respect to FIG. 2. The processing system 1605 may be configured to perform processing functions for the communications device 1600, including processing signals received and/or to be transmitted by the communications device 1600.

The processing system 1605 includes one or more processors 1610 and a computer-readable medium/memory 1635. In various aspects, one or more processors 1610 may be representative of the one or more processors 308, as described with respect to FIG. 3. The one or more processors 1610 are coupled to the computer-readable medium/memory 1635 via a bus 1660. In certain aspects, the computer-readable medium/memory 1635 is configured to store instructions (e.g., computer-executable code), including code 1640-1655, that when executed by the one or more processors 1610, cause the one or more processors 1610 to perform the process 1300 described with respect to FIG. 13, or any aspect related to it, including any operations described in relation to FIG. 13. The computer-readable medium/memory 1635 is a non-transitory computer-readable medium/memory. Note that reference to a processor of communications device 1600 performing a function may include one or more processors of communications device 1600 performing that function, such as in a distributed fashion.

In the depicted example, the computer-readable medium/memory 1635 stores code (e.g., executable instructions), including code for transmitting 1640, code for performing 1645, code for receiving 1650, and code for encoding 1655. Processing of the code 1640-1655 may enable and cause the communications device 1600 to perform the process 1300 described with respect to FIG. 13, or any aspect related to it.

The one or more processors 1610 include circuitry configured to implement (e.g., execute) the code stored in the computer-readable medium/memory 1635, including circuitry for transmitting 1615, circuitry for performing 1620, circuitry for receiving 1625, and circuitry for encoding 1630. Processing with circuitry 1615-1630 may enable and cause the communications device 1600 to perform the process 1300 described with respect to FIG. 13, or any aspect related to it.

Various components of the communications device 1600 may provide means for performing the process 1300 described with respect to FIG. 13, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1665, antenna 1670, and/or network interface 1675 of the communications device 1600 in FIG. 16, and/or one or more processors 1610 of the communications device 1600 in FIG. 16. Means for communicating, receiving or obtaining may include the one or more transceivers 312, one or more antennas 314, and/or processing system 306 of the first network entity 300 or the second network entity 302 illustrated in FIG. 3, transceiver 1665, antenna 1670, and/or network interface 1675 of the communications device 1600 in FIG. 16, and/or one or more processors 1610 of the communications device 1600 in FIG. 16.

### Example Clauses

### Implementation Examples are Described in the Following Numbered Clauses:

Clause 1: A method for wireless communications by a transmitter comprising: encoding information, using polar coding and a polar-transformed labeling, to obtain encoded information, wherein the polar-transformed labeling is according to a polar transformation or an inverse polar transformation of a labeling scheme; and transmitting the encoded information.
Clause 2: The method of Clause 1, wherein encoding the information using polar coding comprises encoding the information based on a set of frozen bits that are derived from the polar-transformed labeling.
Clause 3: The method of any one of Clauses 1-2, wherein encoding the information using polar coding comprises encoding the information using BICM encoding.
Clause 4: The method of Clause 3, wherein the labeling scheme is a set partitioning labeling scheme prior to the polar transformation, wherein the polar transformation uses a polar code of a size m and the set partitioning labeling scheme has an order of m.
Clause 5: The method of Clause 4, wherein encoding the information using polar coding comprises encoding the information based on a set of frozen bits associated with the multi-level coding.
Clause 6: The method of Clause 4, wherein encoding the information using BICM and the polar-transformed labeling is equivalent to encoding the information using multi-level coding and the set partitioning labeling scheme.
Clause 7: The method of any one of Clauses 1-6, wherein encoding the information using polar coding comprises encoding the information using multi-level coding.
Clause 8: The method of Clause 7, wherein the labeling scheme is a Gray labeling scheme prior to the inverse polar transformation, wherein the inverse polar transformation uses an inverse polar code of a size m and the Gray labeling scheme has an order of m.
Clause 9: The method of Clause 8, wherein encoding the information using polar coding comprises encoding the information based on a set of frozen bits associated with the polar-transformed labeling.
Clause 10: The method of Clause 8, wherein encoding the information using multi-level coding and the polar-transformed labeling is equivalent to encoding the information using BICM and the Gray labeling scheme.
Clause 11: The method of Clause 1, further comprising selecting the polar-transformed labeling in accordance with whether the polar coding uses bit-interleaved coded modulation or multi-level coding.
Clause 12: The method of Clause 11, wherein the processing system is configured to cause the transmitter to transmit an indication of the polar-transformed labeling.
Clause 13: A method for wireless communications by a UE comprising: transmitting or receiving a configuration associated with encoding or decoding a communication using polar coding and a polar-transformed labeling; and performing the communication according to the configuration.
Clause 14: The method of Clause 13, wherein the configuration indicates a set of frozen bits associated with the polar-transformed labeling.
Clause 15: The method of any one of Clauses 13-14, wherein the configuration indicates the polar-transformed labeling.
Clause 16: The method of any one of Clauses 13-15, further comprising transmitting capability information that indicates support for one or more configurations, wherein the configuration is one of the one or more configurations, and wherein transmitting or receiving the configuration comprises receiving the configuration.
Clause 17: The apparatus of Clause 16, wherein the capability information indicates support for one or more polar-transformed labelings, one or more sets of frozen bits, or a combination thereof.
Clause 18: The method of any one of Clauses 13-17, wherein transmitting or receiving the configuration comprises transmitting the configuration.
Clause 19: The method of any one of Clauses 13-18, wherein the configuration is at least one of: a radio resource control configuration, a medium access control configuration, or a downlink control information configuration.
Clause 20: The method of any one of Clauses 13-19, wherein the communication comprises a code block and the configuration is specific to the code block.
Clause 21: The method of any one of Clauses 13-20, wherein the communication comprises a code block group and the configuration is specific to the code block group.
Clause 22: The method of any one of Clauses 13-21, wherein the communication occurs in a slot and the configuration is specific to the slot.
Clause 23: The method of any one of Clauses 13-22, wherein performing the communication comprises: encoding input information using the polar coding and the polar-transformed labeling, according to the configuration, to obtain encoded information; and transmitting the encoded information as the communication.
Clause 24: The method of Clause 23, wherein the polar coding is BICM polar coding and the polar-transformed labeling is based on a polar transformation of a set partitioning labeling scheme, wherein the polar transformation uses a polar code of a size m and the set partitioning labeling scheme has an order of m.
Clause 25: The method of Clause 23, wherein the polar coding is MLC polar coding and the polar-transformed labeling is based on a polar transformation of a Gray labeling scheme, wherein the polar transformation uses a polar code of a size m and the set partitioning labeling scheme has an order of m.
Clause 26: A method for wireless communications by a network entity comprising: transmitting or receiving a configuration associated with encoding or decoding a communication using polar coding and a polar-transformed labeling; and performing the communication according to the configuration.
Clause 27: The method of Clause 26, wherein the configuration indicates a set of frozen bits associated with the polar-transformed labeling.
Clause 28: The method of any one of Clauses 26-27, wherein the configuration indicates the polar-transformed labeling.
Clause 29: The method of any one of Clauses 26-28, further comprising receiving capability information that indicates support for one or more configurations, wherein the configuration is one of the one or more configurations, and wherein transmitting or receiving the configuration comprises transmitting the configuration.
Clause 30: The method of Clause 29, wherein the capability information indicates support for one or more polar-transformed labelings, one or more sets of frozen bits, or a combination thereof.
Clause 31: The method of any one of Clauses 26-30, wherein transmitting or receiving the configuration comprises receiving the configuration.
Clause 32: The method of any one of Clauses 26-31, wherein the configuration is at least one of: a radio resource control configuration, a medium access control configuration, or a downlink control information configuration.
Clause 33: The method of any one of Clauses 26-32, wherein the communication comprises a code block and the configuration is specific to the code block.
Clause 34: The method of any one of Clauses 26-33, wherein the communication comprises a code block group and the configuration is specific to the code block group.
Clause 35: The method of any one of Clauses 26-34, wherein the communication occurs in a slot and the configuration is specific to the slot.
Clause 36: The method of any one of Clauses 26-35, wherein performing the communication comprises: encoding input information using the polar coding and the polar-transformed labeling, according to the configuration, to obtain encoded information; and transmitting the encoded information as the communication.
Clause 37: The method of Clause 36, wherein the polar coding is BICM polar coding and the polar-transformed labeling is based on a polar transformation of a set partitioning labeling scheme, wherein the polar transformation uses a polar code of a size m and the set partitioning labeling scheme has an order of m.
Clause 38: The method of Clause 36, wherein the polar coding is MLC polar coding and the polar-transformed labeling is based on a polar transformation of a Gray labeling scheme, wherein the polar transformation uses a polar code of a size m and the set partitioning labeling scheme has an order of m.
Clause 39: The method of any of Clauses 1-38, further comprising mapping an output of the polar coding to the polar-transformed labeling.
Clause 40: One or more apparatuses, comprising: one or more memories comprising executable instructions; and one or more processors configured to execute the executable instructions and cause the one or more apparatuses to perform a method in accordance with any one of Clauses 1-39.
Clause 41: One or more apparatuses configured for wireless communications, comprising: one or more memories; and one or more processors, coupled to the one or more memories, configured to cause the one or more apparatuses to perform a method in accordance with any one of Clauses 1-39.
Clause 42: One or more apparatuses configured for wireless communications, comprising: one or more memories; and one or more processors, coupled to the one or more memories, configured to perform a method in accordance with any one of Clauses 1-39.
Clause 43: One or more apparatuses, comprising means for performing a method in accordance with any one of Clauses 1-39.
Clause 44: One or more non-transitory computer-readable media comprising executable instructions that, when executed by one or more processors of one or more apparatuses, cause the one or more apparatuses to perform a method in accordance with any one of Clauses 1-39.
Clause 45: One or more computer program products embodied on one or more computer-readable storage media comprising code for performing a method in accordance with any one of Clauses 1-39.
Clause 46: One or more apparatuses configured for wireless communications, comprising: a processing system that includes one or more processors and one or more memories coupled with the one or more processors, the processing system configured to cause the one or more apparatuses to perform a method in accordance with any one of Clauses 1-39.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communications, the apparatus comprising a processing system that includes one or more processors and one or more memories coupled with the one or more processors, the processing system configured to cause a transmitter to:
encode information, using polar coding and a polar-transformed labeling, to obtain encoded information, wherein the polar-transformed labeling is according to a polar transformation or an inverse polar transformation of a labeling scheme; and
transmit the encoded information.

2. The apparatus of claim 1, wherein to cause the transmitter to encode the information using polar coding, the processing system is configured to cause the transmitter to encode the information based on a set of frozen bits that are derived from the polar-transformed labeling.

3. The apparatus of claim 1, wherein to cause the transmitter to encode the information using polar coding, the processing system is configured to cause the transmitter to encode the information using bit-interleaved coded modulation (BICM) encoding.

4. The apparatus of claim 3, wherein the labeling scheme is a set partitioning labeling scheme prior to the polar transformation, wherein the polar transformation uses a polar code of a size m and the set partitioning labeling scheme has an order of m.

5. The apparatus of claim 4, wherein, to cause the transmitter to encode the information using polar coding, the processing system is configured to cause the transmitter to encode the information based on a set of frozen bits associated with the multi-level coding.

6. The apparatus of claim 4, wherein encoding the information using BICM and the polar-transformed labeling is equivalent to encoding the information using multi-level coding and the set partitioning labeling scheme.

7. The apparatus of claim 1, wherein to cause the transmitter to encode the information using polar coding, the processing system is configured to cause the transmitter to encode the information using multi-level coding.

8. The apparatus of claim 7, wherein the labeling scheme is a Gray labeling scheme prior to the inverse polar transformation, wherein the inverse polar transformation uses an inverse polar code of a size m and the Gray labeling scheme has an order of m.

9. The apparatus of claim 8, wherein, to cause the transmitter to encode the information using polar coding, the processing system is configured to cause the transmitter to encode the information based on a set of frozen bits associated with the polar-transformed labeling.

10. The apparatus of claim 8, wherein encoding the information using multi-level coding and the polar-transformed labeling is equivalent to encoding the information using bit-interleaved coded modulation (BICM) and the Gray labeling scheme.

11. The apparatus of claim 1, wherein, to cause the transmitter to encode the information using polar coding and the polar-transformed labeling, the processing system is configured to cause the transmitter to map an output of the polar coding to the polar-transformed labeling.

12. The apparatus of claim 1, wherein the processing system is configured to cause the transmitter to select the polar-transformed labeling in accordance with whether the polar coding uses bit-interleaved coded modulation or multi-level coding.

13. The apparatus of claim 12, wherein the processing system is configured to cause the transmitter to transmit an indication of the polar-transformed labeling.

14. An apparatus for wireless communications, comprising a processing system that includes one or more processors and one or more memories coupled with the one or more processors, the processing system configured to cause a user equipment (UE) to:
transmit or receive a configuration associated with encoding or decoding a communication using polar coding and a polar-transformed labeling; and
perform the communication according to the configuration.

15. The apparatus of claim 14, wherein the configuration indicates a set of frozen bits associated with the polar-transformed labeling.

16. The apparatus of claim 14, wherein the configuration indicates the polar-transformed labeling.

17. The apparatus of claim 14, wherein the processing system is configured to cause the UE to transmit capability information that indicates support for one or more configurations, wherein the configuration is one of the one or more configurations, and wherein to cause the UE to transmit or receive the configuration, the processing system is configured to cause the UE to receive the configuration.

18. The apparatus of claim 17, wherein the capability information indicates support for one or more polar-transformed labelings, one or more sets of frozen bits, or a combination thereof.

19. The apparatus of claim 14, wherein to cause the UE to transmit or receive the configuration, the processing system is configured to cause the UE to transmit the configuration.

20. The apparatus of claim 14, wherein the communication comprises a code block or a code block group and the configuration is specific to the code block or the code block group.

21. The apparatus of claim 14, wherein the communication occurs in a slot and the configuration is specific to the slot.

22. The apparatus of claim 14, wherein to cause the UE to perform the communication, the processing system is configured to cause the UE to:
encode input information using the polar coding and the polar-transformed labeling, according to the configuration, to obtain encoded information; and
transmit the encoded information as the communication.

23. The apparatus of claim 22, wherein the polar coding is bit-interleaved coded modulation (BICM) polar coding and the polar-transformed labeling is based on a polar transformation of a set partitioning labeling scheme, wherein the polar transformation uses a polar code of a size m and the set partitioning labeling scheme has an order of m.

24. The apparatus of claim 22, wherein the polar coding is multi-level coding (MLC) polar coding and the polar-transformed labeling is based on an inverse polar transformation of a Gray labeling scheme, wherein the inverse polar transformation uses a polar code of a size m and the Gray labeling scheme has an order of m.

25. An apparatus for wireless communications, comprising a processing system that includes one or more processors and one or more memories coupled with the one or more processors, the processing system configured to cause a network entity to:
transmit or receive a configuration associated with encoding or decoding a communication using polar coding and a polar-transformed labeling; and
perform the communication according to the configuration.

26. The apparatus of claim 25, wherein the configuration indicates a set of frozen bits associated with the polar-transformed labeling.

27. The apparatus of claim 25, wherein the configuration indicates the polar-transformed labeling.

28. The apparatus of claim 25, wherein the processing system is configured to cause the network entity to receive capability information that indicates support for one or more configurations, wherein the configuration is one of the one or more configurations, and wherein to cause the network entity to transmit or receive the configuration, the processing system is configured to cause the network entity to transmit the configuration.

29. The apparatus of claim 28, wherein the capability information indicates support for one or more polar-transformed labelings, one or more sets of frozen bits, or a combination thereof.

30. The apparatus of claim 25, wherein to cause the network entity to transmit or receive the configuration, the processing system is configured to cause the network entity to receive the configuration.
